(19) United States
(12) Patent Application Publication
(10) Pub. No.: US 2011/0264582 A1
(43) Pub. Date: Oct. 27, 2011

(54) DIRECT BILL PAYMENT APPARATUSES, METHODS AND SYSTEMS

(76) Inventors: James Kim, San Mateo, CA (US); Jeffrey Morris Sachs, Forster City, CA (US)

(21) Appl. No.: 13/071,072

(22) Filed: Mar. 24, 2011

Related U.S. Application Data
(60) Provisional application No. 61/317,102, filed on Mar. 24, 2010.

(51) Int. Cl. G06Q 40/00

(52) U.S. Cl. 705/40

(57) ABSTRACT

The DIRECT BILL PAYMENT APPARATUSES, METHODS AND SYSTEMS (“DBP”) transform location-specific providers search queries via DBP components into automated recurring bill notifications and payments. In one embodiment, the DBP obtains an indication to execute a pre-recorded web navigation automation script for user bill payment. The DBP parses the obtained indication to identify a user and a bill associated with the user, and accesses a pre-recorded web navigation automation script for payment of the bill associated with the identified user. The DBP executes an automated web navigation action based on the pre-recorded web navigation automation script. In some implementations, the DBP parses the pre-recorded web navigation script and identifies a command included in the pre-recorded web navigation automation script. The DBP executes the automated web navigation action according to the identified command included in the pre-recorded web navigation automation script.

### RELATED APPLICATIONS

Applicant hereby claims priority under 35 USC §119 for U.S. provisional patent application Ser. No. 61/317,102, filed Mar. 24, 2010, entitled “Bill Pay Service,” attorney docket no. P-41268PRV|20270-112PV. The entire contents of the aforementioned application are herein expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for transaction processing, and more particularly, to DIRECT BILL PAYMENT APPARATUSES, METHODS AND SYSTEMS (“DBP”).

### BACKGROUND

Users may utilize numerous products and/or services on a recurring basis from various vendors, merchants, service providers, and/or the like. Such vendors, merchants, service providers, etc. may have differing bill payment methods and due dates for payment in lieu of their offerings. Also, users may seek additional products and/or services from vendors, merchants and service providers who are located in the vicinity of the users.

### BRIEF DESCRIPTION OF THE DRAWINGS

The accompanying appendices and/or drawings illustrate various non-limiting, example, inventive aspects in accordance with the present disclosure:

FIG. 1 shows a block diagram illustrating example aspects of direct bill payment in some embodiments of the DBP;

FIGS. 2A-Q show application user interface diagrams illustrating example aspects of aggregated user bill payment management in some embodiments of the DBP;

FIGS. 3A-C show data flow diagrams illustrating an example procedure to add a new user bill from a merchant, vendor, service provider and/or the like, and program automated recurring bill payment of the new user bill in some embodiments of the DBP;

FIGS. 4A-E show logic flow diagrams illustrating example aspects of adding a new user bill from a merchant, vendor, service provider and/or the like, and programming automated recurring bill payment of the new user bill in some embodiments of the DBP, e.g., a New Bill Addition (“NBA”) component 400;

FIGS. 5A-D show data flow diagrams illustrating an example procedure to execute a card-based transaction to pay an outstanding user bill expense due to a merchant in some embodiments of the DBP;

FIGS. 6A-D show logic flow diagrams illustrating example aspects of executing a card-based transaction to pay an outstanding user bill expense due to a merchant in some embodiments of the DBP, e.g., a Card-Based Transaction Execution (“CTE”) component 600; and

FIG. 7 shows a block diagram illustrating embodiments of a DBP controller; and

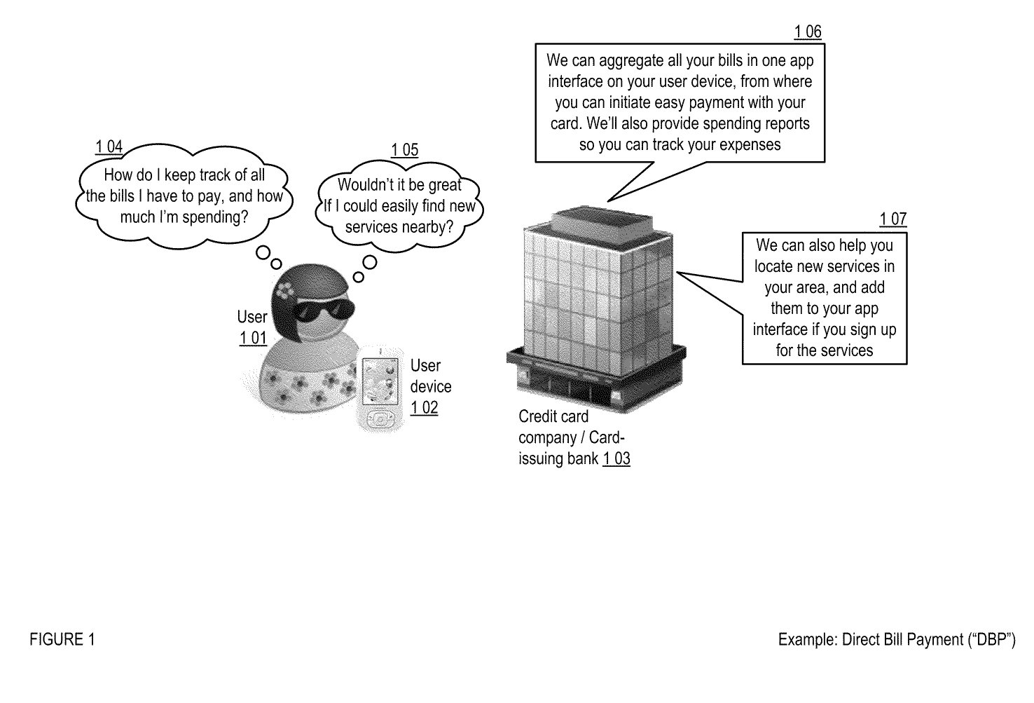

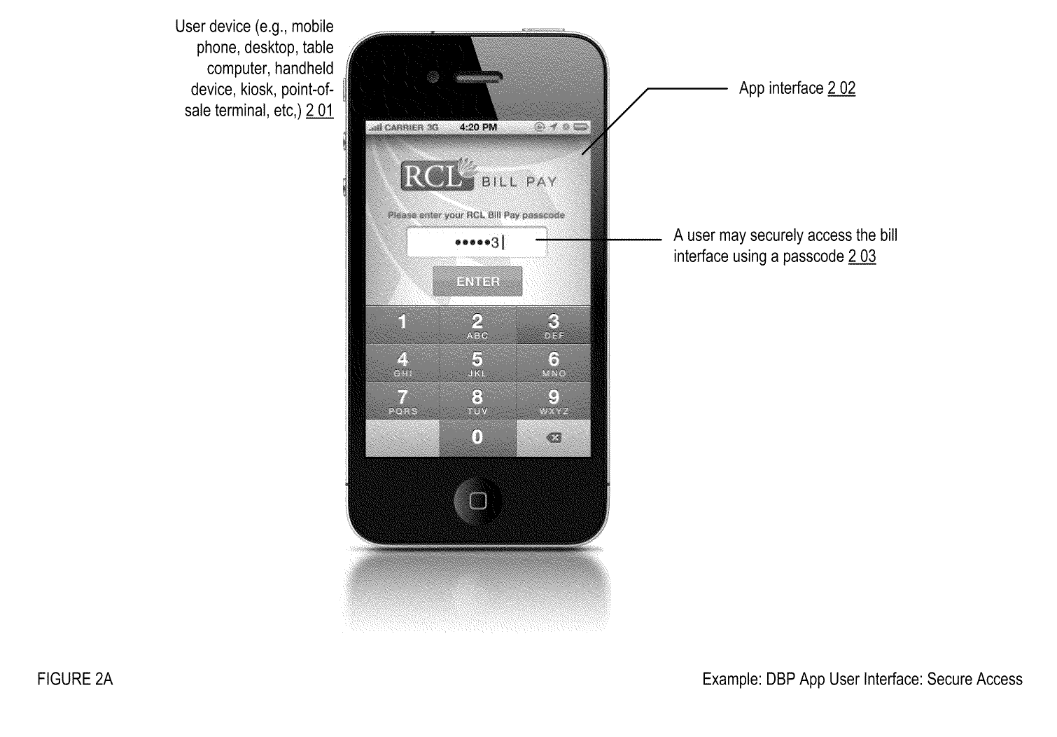

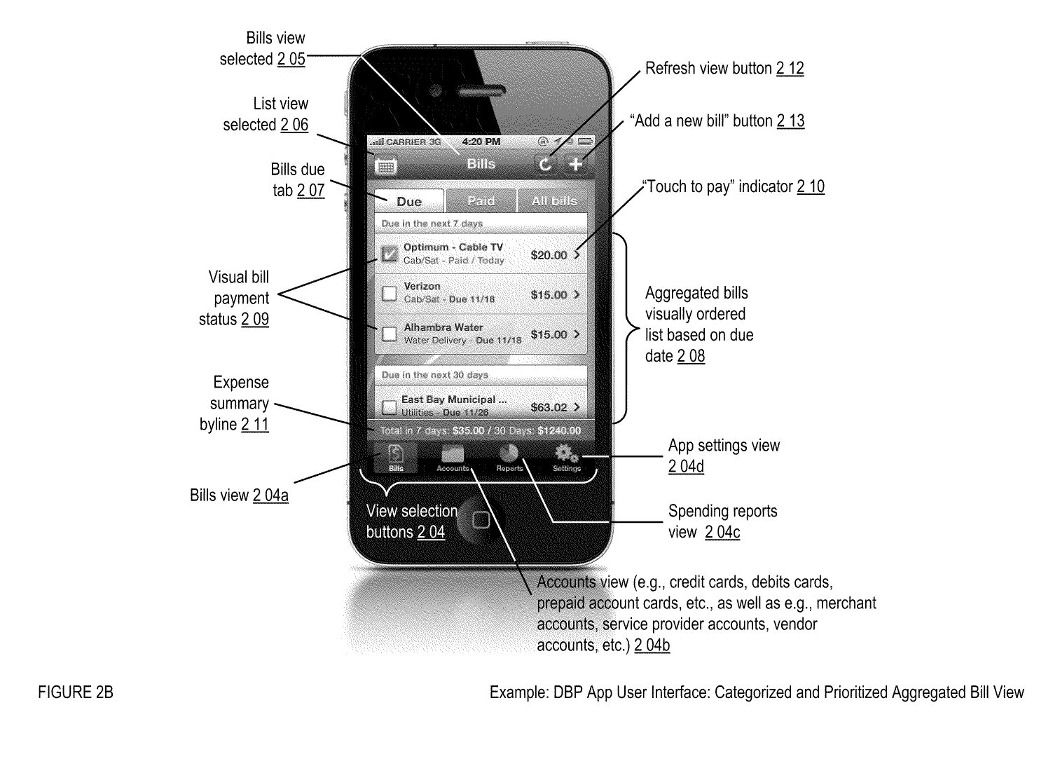

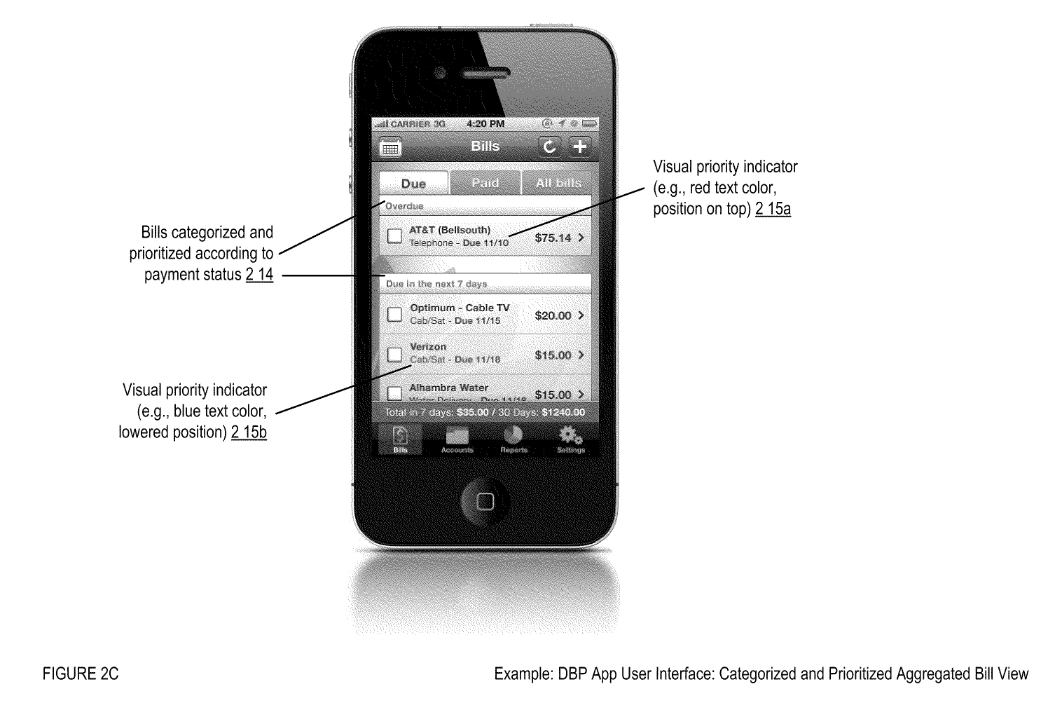

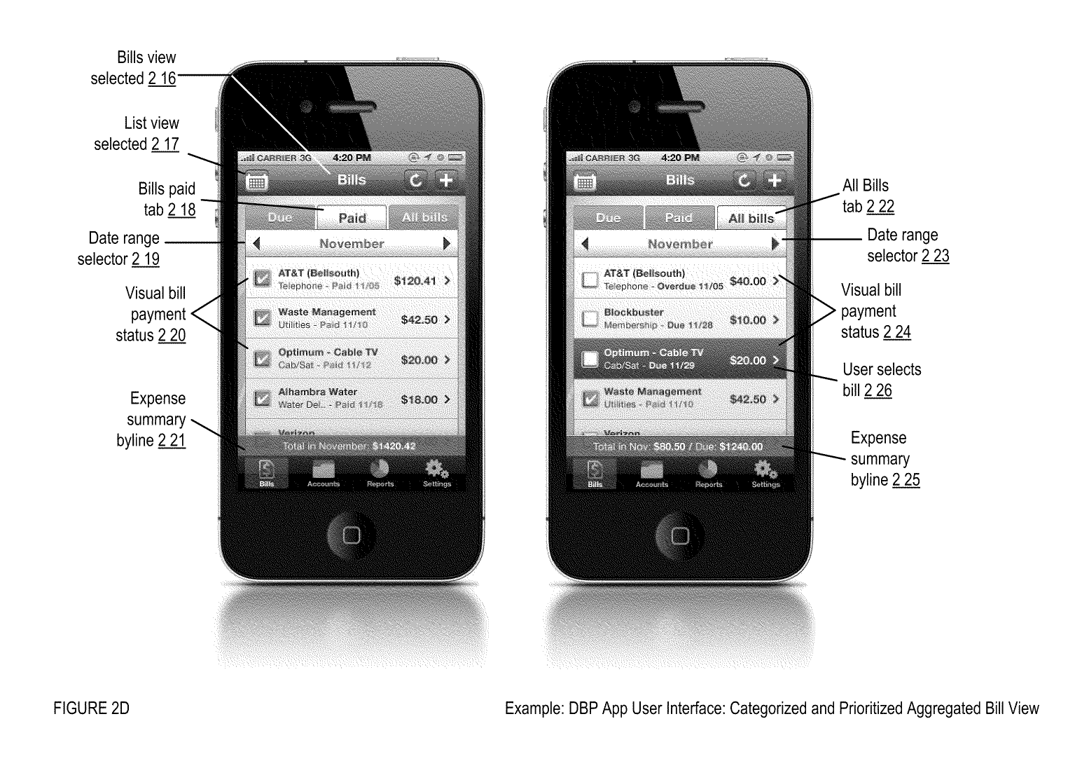

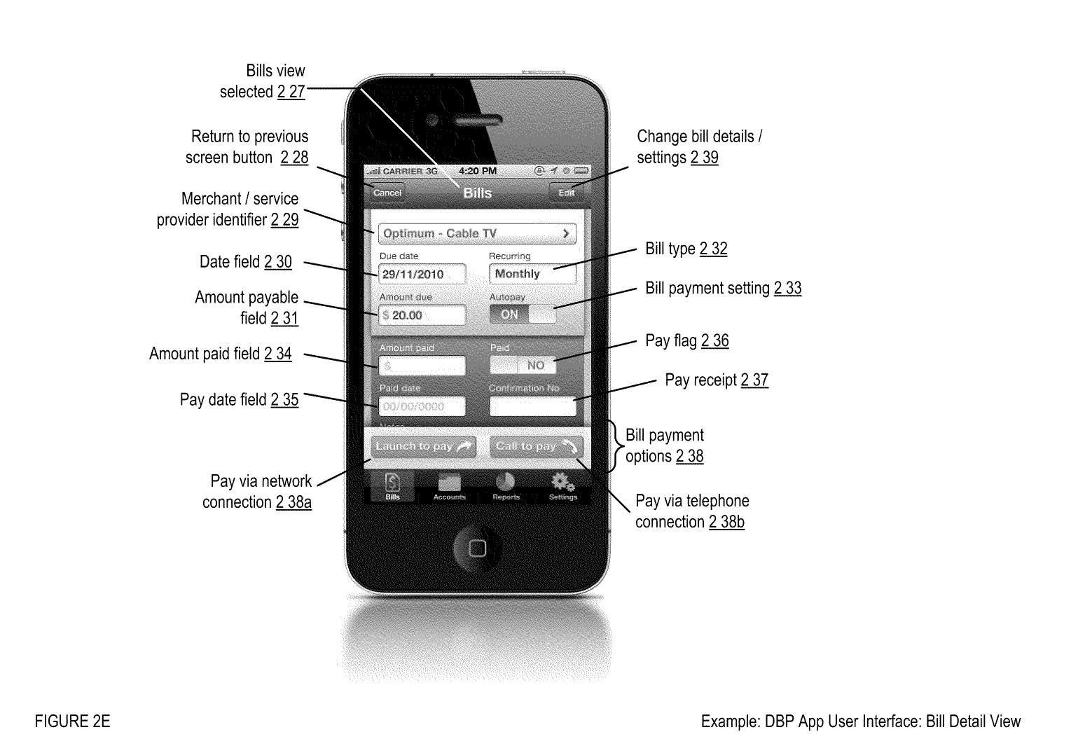

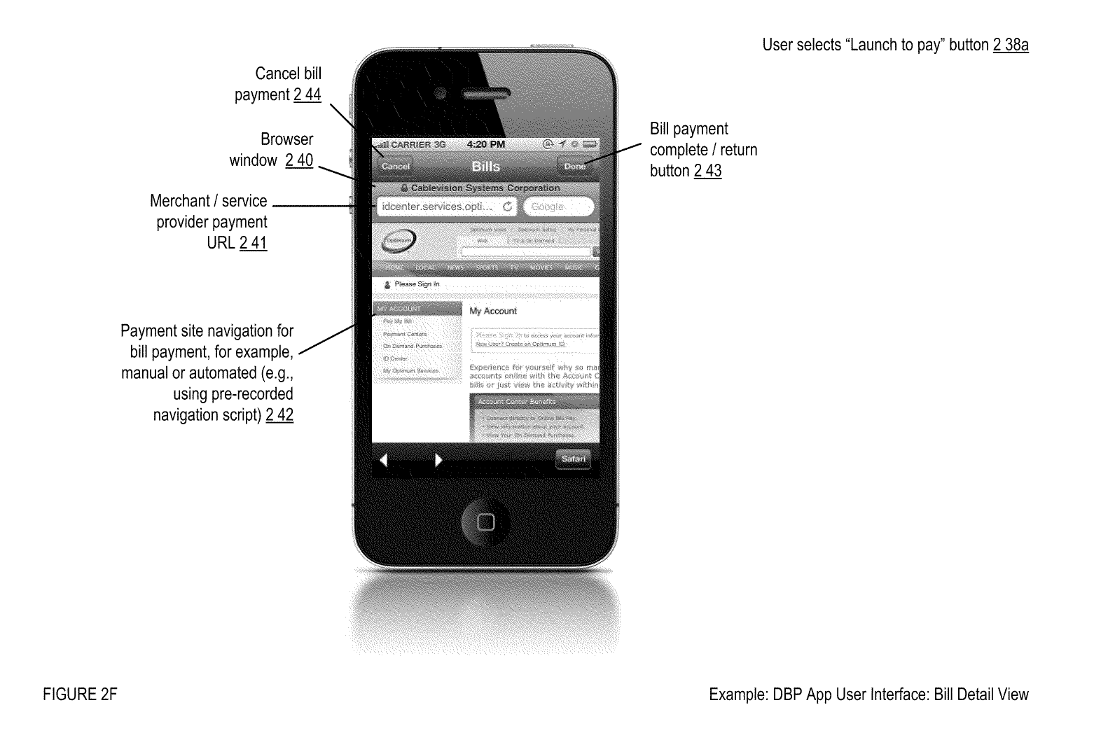

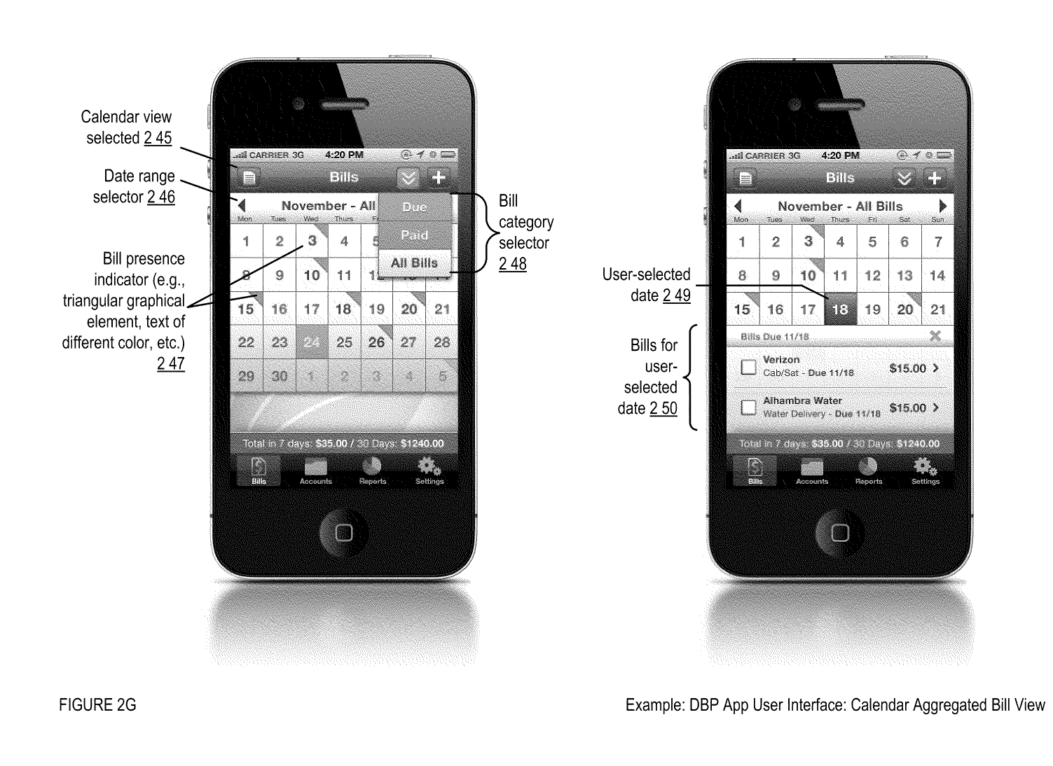

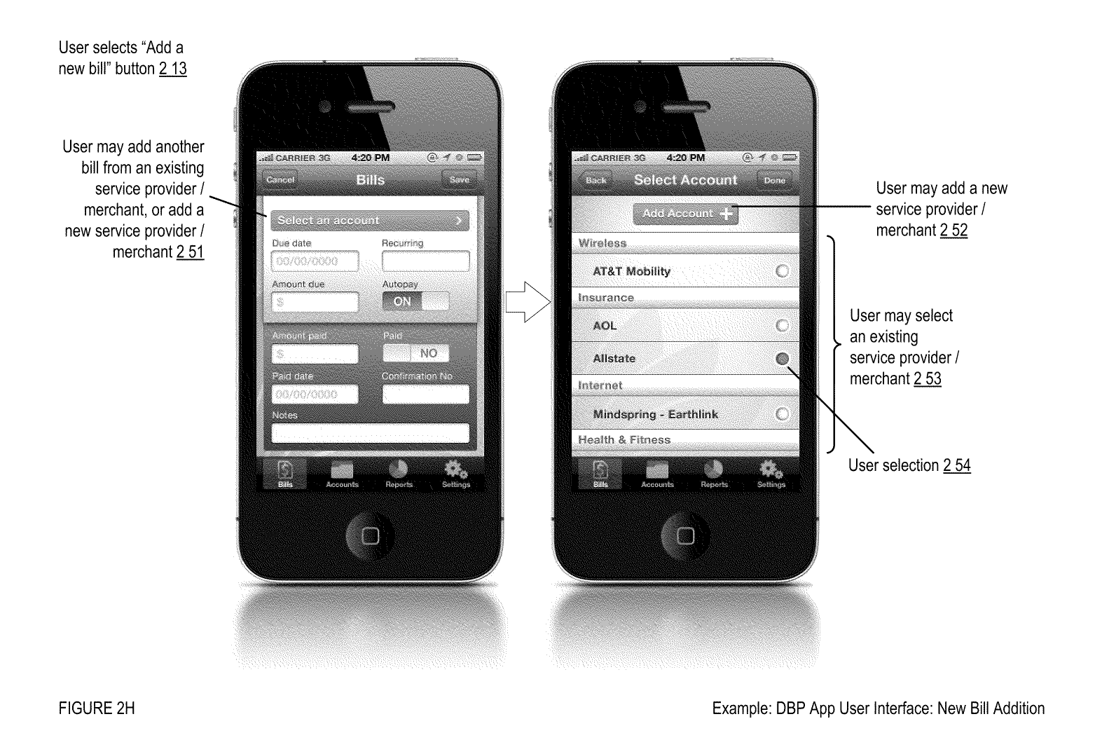

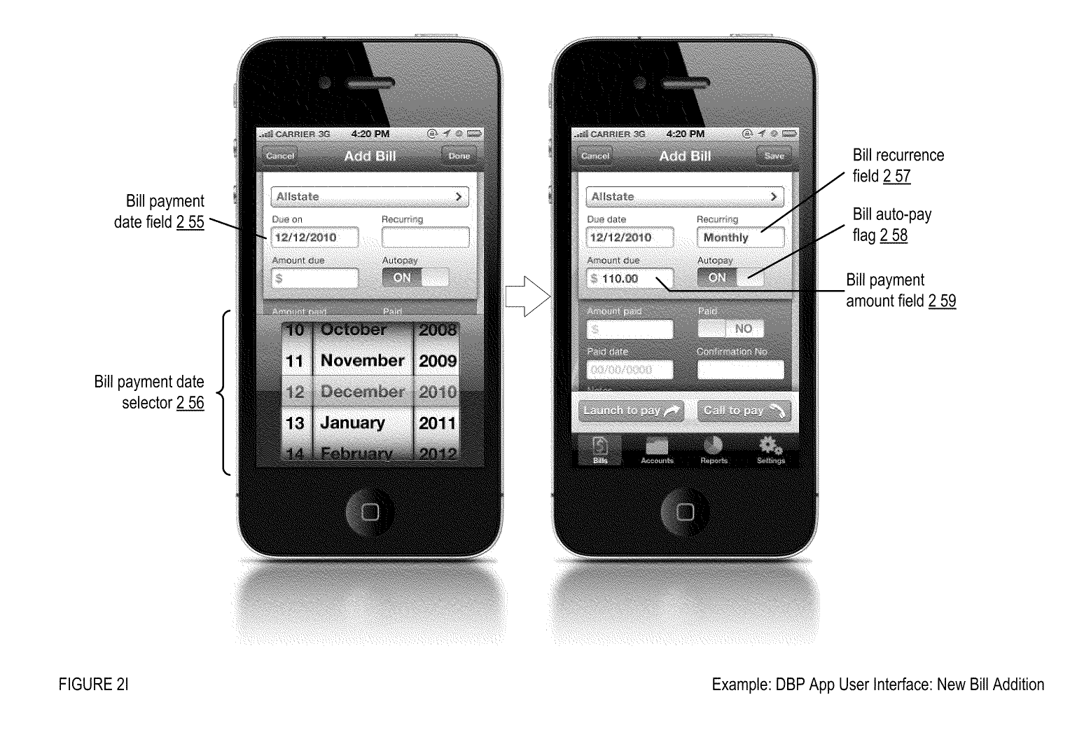

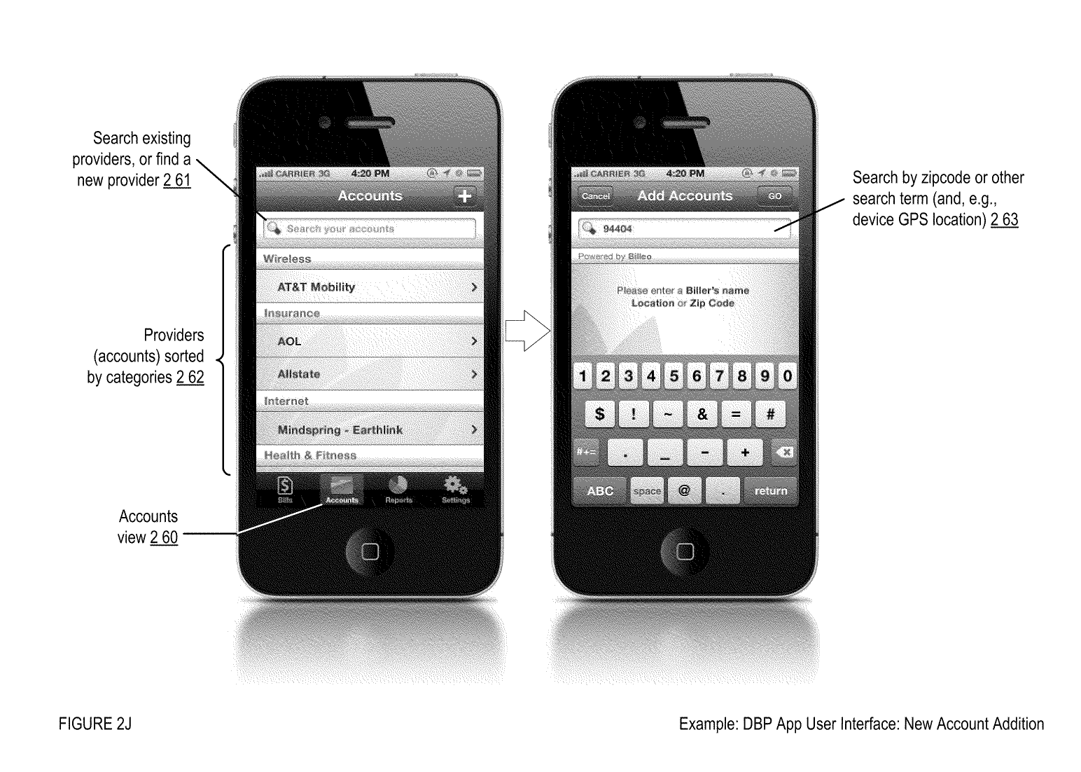

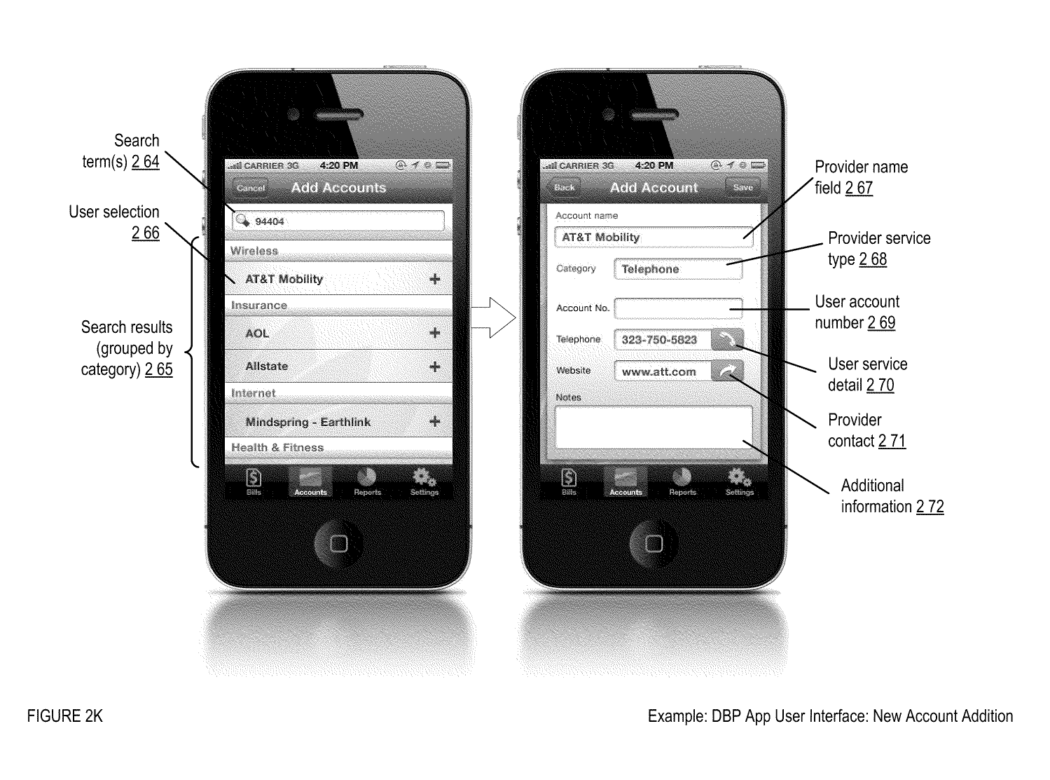

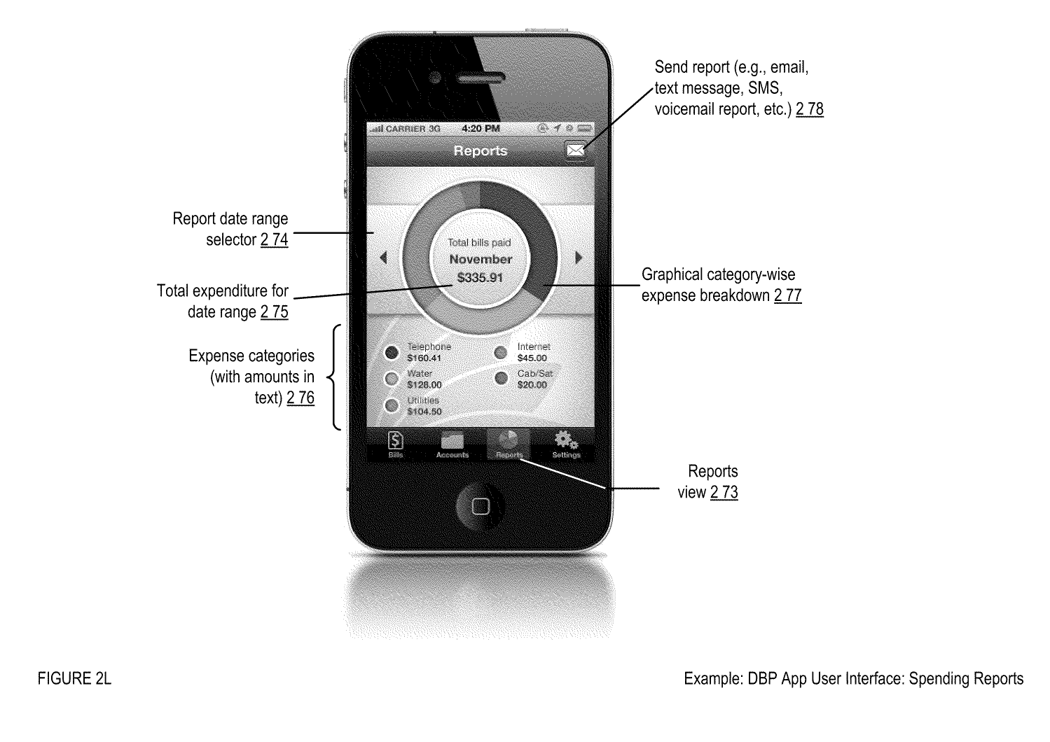

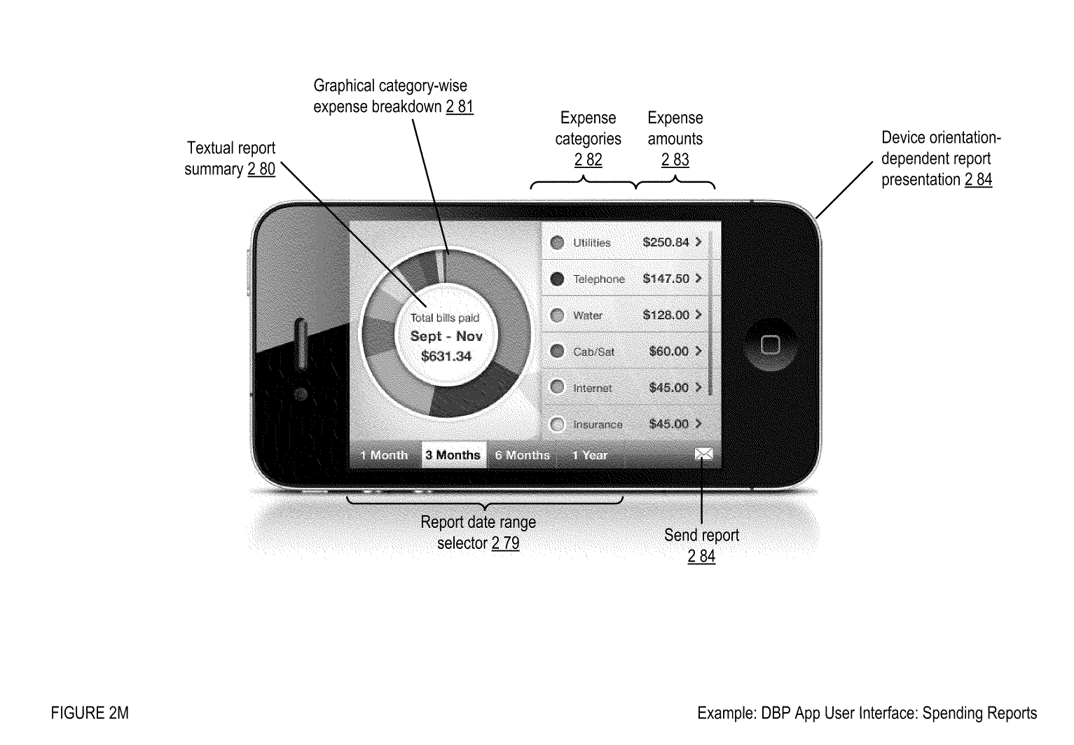

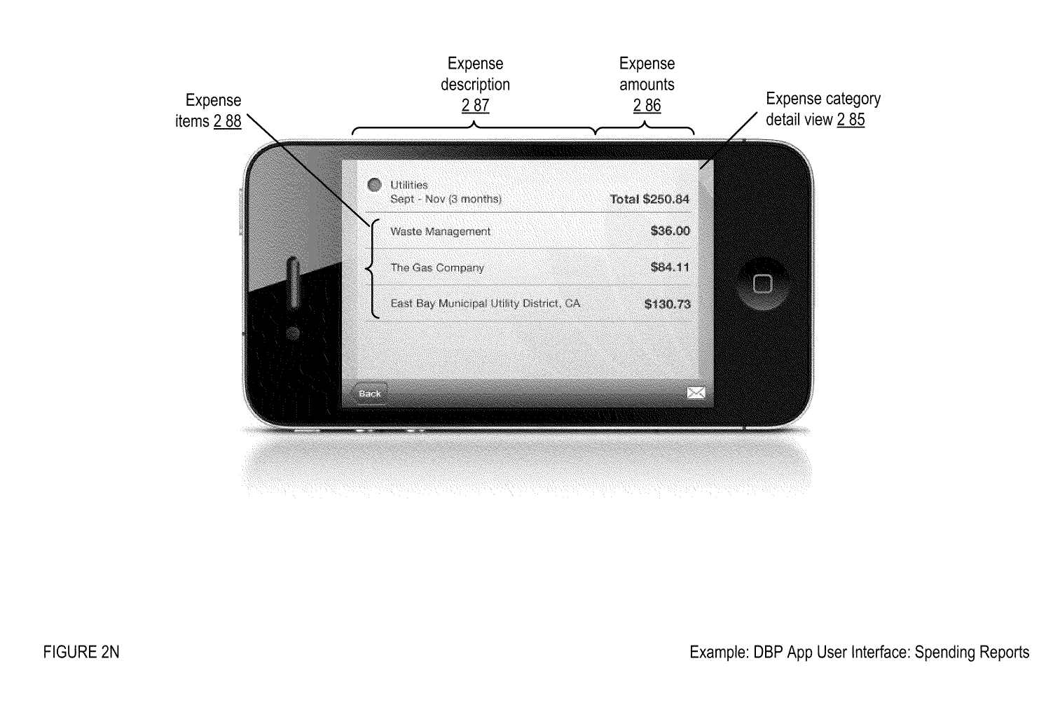

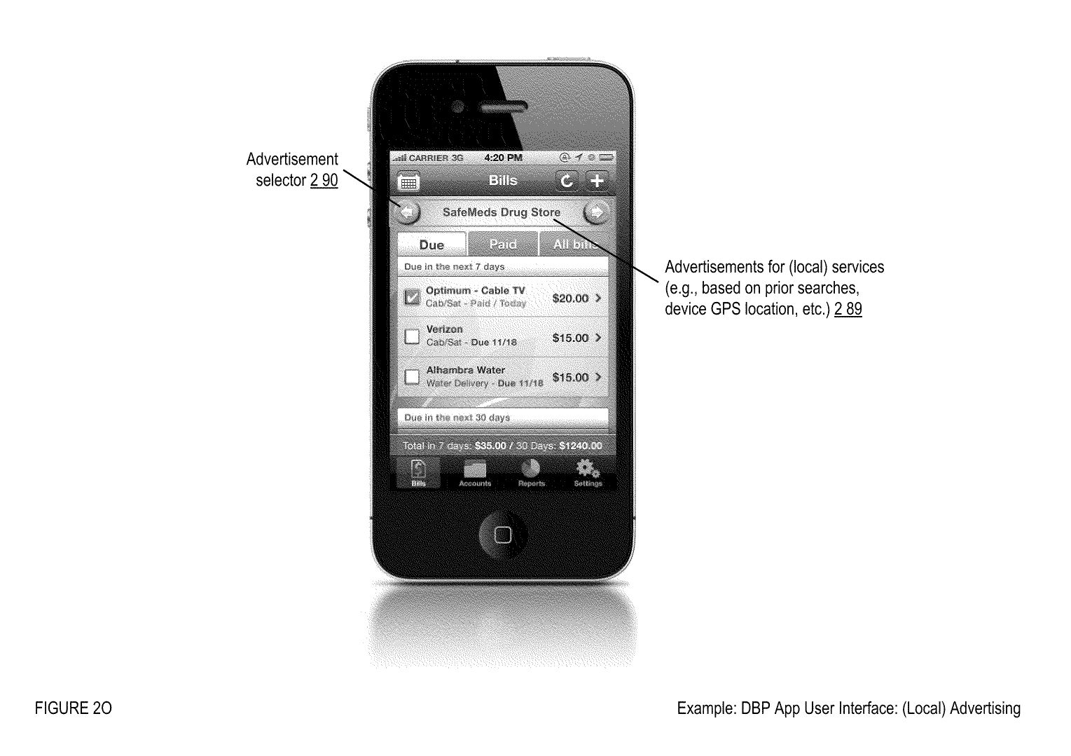

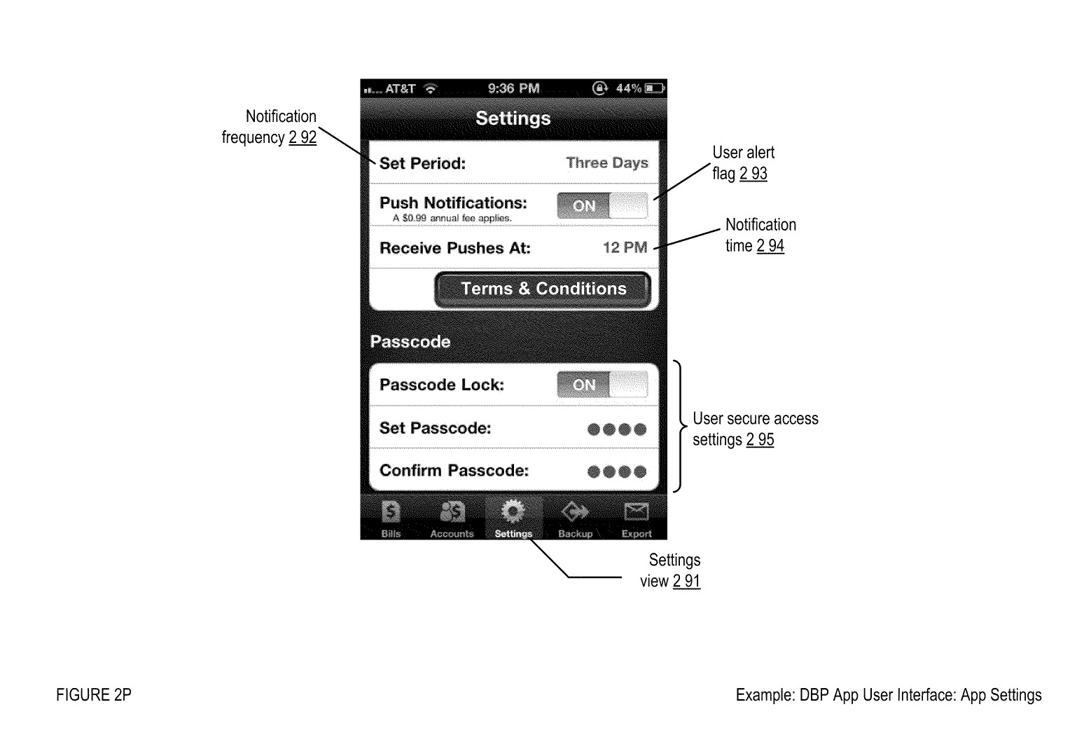

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Direct Bill Payment (DBP)

The DIRECT BILL PAYMENT APPARATUSES, METHODS AND SYSTEMS (hereinafter “DBP”) transform location-specific providers search queries, via DBP components, into automated recurring bill notifications and payments.

FIG. 1 shows a block diagram illustrating example aspects of direct bill payment in some embodiments of the DBP. In some implementations, the DBP may enable a user to keep track of the user's bills via a single user interface operating on a client device of the user. For example, a user, e.g., 101, may have a user device, e.g., 102. The user may utilize numerous products and/or services (“offerings”) on a recurring basis from various vendors, merchants, service providers, and/or the like (“merchants”), see e.g., 104. In some implementations, each of the merchants may have differing bill payment methods and due dates for payment of bills for their offerings. In some implementations, the user may utilize one or more cards from a card company, e.g., credit card company/card-issuing bank 103, to pay the bills for the offerings the user may utilize from the merchants. In some implementations, the DBP may provide an app for installation on the user device. The app may provide an aggregated view of all the bills of the user associated with the various offerings that the user may be utilizing from the merchants, see e.g., 106. In some implementations, the user may desire to discover new merchants and/or offerings. For example, the user may desire to find new merchants and/or offerings that are in the geographical vicinity of the user. In some implementations, the DBP may enable the user to locate new services in the vicinity of the user, see e.g., 107. For example, the DBP may utilize the app installed on the user device to determine the geographical location of the user, e.g., via Global Positioning System (“GPS”) tracking. Using the geographical locations of the user, the DBP may provide the user with notifications of nearby merchants and/or their offerings. In some implementations, the DBP may enable the user to sign up for the services of the new merchant and add the bills of the new merchant to the interface of the app executing on the user device. In some implementations, the DBP may provide spending reports for the user for the user to keep track of the user's expenses, see e.g., 106. For example, the app executing on the user device may provide presentations including breakdowns of such expenses according to various parameters including: by spending category, by date range (e.g., by day, week, month, year, etc.), by merchant. Various other example inventive aspects of the DBP are described further below.

FIGS. 2A-Q show application user interface diagrams illustrating example aspects of aggregated user bill payment management in some embodiments of the DBP. With reference to FIG. 2A, in some implementations, the DBP may provide an app for a user device the user for direct bill payment. For example, the user may operate a device such as, but not limited to: a personal computer, mobile device, television, point-of-sale terminal, kiosk, ATM, and/or the like, e.g., 201. For example, the app may be an executable application developed using a Software Development Kit (SDK) such as iOS SDK 4, Xcode 4, Android SDK, Visual Studio, Visual C++, Java EE 5 SDK, GTK+, GNUstep, wxWidgets, and/or the like. In some implementations, the app executing on the user device may provide a user interface, e.g., 202, using which the user may interact with the app executing on the user device. For example, the user may provide various types of input, including but not limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. In some implementations, the app may include a security feature to allow a user secure access to the interface providing the aggregated bill management features, e.g., 203. As an example, a user may enter a passcode to access the bill interface of the app. As another example, the user may present a card (e.g., a credit card, debit card, prepaid card, etc.) at the user device to gain access to the bill interface of the app. For example, the user may swipe the card through a card reader of the user device, present the card for a Near-Field Communications (NFC) card reader, Bluetooth reader, and/or the like. The user device may obtain, e.g., track 1 data from the user's card such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

The user device may then authenticate the user based on, e.g., whether the user identification from the card data matches the identification of the user to whom the user device is registered, or whether the card number of the user matches the card used for user bill payments via the app, etc. Upon authentication, the app may provide the bill interface for the user. In some implementations, the user device executing the app may provide a number of outputs for the user including, but not limited to: sounds, music, audio, video, images, tactile feedback, vibration alerts (e.g., on vibration-capable client devices such as a smartphone etc.), and/or the like.

With reference to FIG. 2B, in some implementations, the interface may include elements providing various features for the user. For example, the user interface may include elements, e.g., 204, providing the user the option to: view the user's bills aggregated together, e.g., bills view 204a element; view accounts, e.g., 204b, of the user such as credit card, debit card, prepaid card accounts, etc., as well as merchant accounts, service provider accounts, vendor accounts, etc.; spending reports, e.g., 204c, providing analysis of expenses of the user based on the bill payments made through the app executing on the user device; app settings, e.g., 204d, such as settings for user alters, notifications, alarms, automated bill payments, etc.

In some implementations, a user may select a bills view, e.g., by activating the bills view element 204a. The app may provide an indication to the user that the bills view has been selected, e.g., 205. In some implementations, the app may present aggregated bills of the user from various merchants, service providers, vendors, etc. In some implementations, the app may present the aggregated bills in a list view, e.g., 208. For example, the user may select the bills list view by activating an interface element such as list view selected element 206. The app may then present the aggregated bills of the user in a list form, e.g., 208. In some implementations, the app may provide a list of bills sorted in order of a priority. For example, the list may be sorted according to bill due date (see e.g., 208), bill amount, penally for nonpayment of the bill, and/or the like priority attributes. In some implementations, the app may categorize the bills according to payment status, e.g., bills due, bills unpaid, bills overdue, all bills (uncategorized), etc. For example, the app may provide separate tab elements, e.g., bills due tab 207, for each of the categories of bills. In alternate implementations, the app may utilize various alternate categories, e.g., utilities, discretionary items, recurring items, high-price-tag items, entertainment, dining, etc. In some implementations, attributes of each bill within the bill view may be represented within the interface graphically and/or in text. Bill attributes include, but are not limited to: merchant name, merchant type, bill type, payment status, bill amount, and/or the like. In some implementations, a visual payment status indicator, e.g., 209, may indicate whether a bill is unpaid, overdue, paid, etc. In some implementations, the app interface may include an element which the user may activate to pay the bill, e.g., “Touch to pay” indicator 210. For example, when the user activates the indicator, or the graphical element enclosing the depiction of the bill attributes, the app may initiate a procedure for payment of the bill corresponding to the graphical element and/or the indicator. In some implementations, the app may provide a summary of the status of aggregated bills of the user, e.g., expense summary byline 211. For example, the summary may provide an aggregated amount due by the user to all merchants over an upcoming, present or past date range (e.g., expense summary byline 211, “Total in 7 days: $35.00/30 Days: $1240.00”). In some implementations, the user may make various modifications to the bills, accounts, app settings, and/or other elements within the interface. In some implementations, the app interface may include a view refresh button, e.g., 212, to refresh the graphical view of the interface. In some implementations, the app interface may include an element to initiate addition of a new bill to the aggregation of user bills, e.g., “Add a new bill” button 213, as discussed in greater detail below.

With reference to FIG. 2C, in some implementations, the app may provide a listing of bills categorized according to payment status, e.g., 214, and sorted according to payment priority, see 215a-b. For example, all due bills may be listed separately when the user activates a “Due” tab element within the interface, while paid bills may be displayed separately upon the user activating a “Paid” tab element in the interface. In some implementations, each bill depicted within the interface may include one or more visual priority indicators. For example, a bill that has a high priority for payment may be positioned higher in the interface than a bill that has a low priority for payment. For example, bills that are overdue may be positioned above bills that will become due in the future (see e.g., 214). As another example, the text and/or graphical elements used to present an attribute of a bill may be varied to convey the priority level of the bill. For example, a bill that is overdue may be depicted using red-colored text, e.g., 215a, compared to a bill that is only due being depicted using blue-colored text, e.g., 215b.

With reference to FIG. 2D, in some implementations, a user may select a bills view, and the app may provide an indication to the user that the bills view has been selected, e.g., 216. In some implementations, the app may present aggregated bills of the user from various merchants, service providers, vendors, etc. In some implementations, the app may present the aggregated bills in a list view. For example, the user may select the bills list view by activating an interface element such as list view selected element 217. In some implementations, the app may categorize the bills according to payment status, e.g., bills due, bills unpaid, bills overdue, all bills (uncategorized), etc. For example, the app may provide separate tab elements, e.g., bills paid tab 218, for each of the categories of bills. In alternate implementations, the app may utilize various alternate categories, e.g., utilities, discretionary items, recurring items, high-price-tag items, entertainment, dining, etc. In some implementations, the app may provide a user interface element which the user may activate to select a date range, e.g., date range selector 219. For example, upon selection of a date range within the bills paid tab when the list view is selected, the app may present a list of all bills that have been paid by the user within the selected date range (e.g., “November”). In some implementations, attributes of each bill within the bill view may be represented within the interface graphically and/or in text. Bill attributes include, but are not limited to: merchant name, merchant type, bill type, payment status, bill amount, and/or the like. In some implementations, a visual payment status indicator, e.g., 220, may indicate whether a bill is unpaid, overdue, paid, etc. For example, when under the bills paid tab, only bills that have been paid may appear, thus only bills that have a green checkbox may appear in such a view. In some implementations, the app may provide a summary of the status of aggregated bills of the user, e.g., expense summary byline 221. For example, the summary may provide an aggregated amount paid by the user to all merchants over the selected date range (e.g., expense summary byline 221, “Total in November: $1420.42”).

In some implementations, the app may provide an uncategorized listing of all the bills associated with the user. For example, the app may provide such an uncategorized listed when the user activates an All bills tab, e.g., 222. In some implementations, the app may provide an element which the user may activate to select a date range, e.g., date range selector 223, to present the uncategorized bills list. For example, upon selection of a date range within the All bills tab when the list view is selected, the interface may present a list of all bills within the selected date range (e.g., “November”). In some implementations, attributes of each bill within the bill view may be represented within the interface graphically and/or in text. In some implementations, a visual payment status indicator, e.g., 224, may indicate whether a bill is unpaid, overdue, paid, etc. In some implementations, the app may provide a summary of the status of aggregated bills of the user, e.g., expense summary byline 225. For example, the summary may provide an aggregated amount paid by the user to all merchants and due to all merchants within the selected date range (e.g., expense summary byline 225, “Total in November: $80.50/Due: $1240.00”).

With reference to FIG. 2E, in some implementations, a user may activate an element within the app interface to obtain a detail view of a user bill. For example, the user may select, e.g., 226 (FIG. 2D), a bill from an aggregated bill list view. In such implementations, the interface may provide a bill view and may provide an indication that a bills view has been selected (e.g., bills view selected 227). In some implementations, the user may return to a prior interface view by selecting a “Cancel” element, e.g., return to previous screen button 228. The detail view within the interface may provide various attributes of the bill. Such attributes may include, but not be limited to: merchant/service provider identifier (e.g., 229), bill date (e.g., date field 230), amount payable (e.g., amount payable field 231), bill recurrence type (e.g., bill type 232), bill payment settings (e.g., 233), amount paid (e.g., 234), last amount pay date (e.g., pay date field 235), a bill paid flag (e.g., 236), payment confirmation identifier (e.g., pay receipt 237), and/or the like. For example, the user device may store the attributes of each user bill as a data structure in the memory of the user device. For example, the user device may store a bill data structure encoded according to the eXtensible Markup Language (“XML”), such as the example provided below:

<bill>

<bill_ID>Q438CBRE8</bill_ID>
<last_modified>2011-03-20</last_modified>
<user_id>john.q.public@dbp.com</user_id>
<client>

<client_ID>AD-EG-HG-AW-45-65-78-90</client_ID>
<client_IP>129.78.43.543</client_IP>
<client_MAC> 01:23:45:67:89:FF</client_MAC>

</client>
<merchant>

<merchant_ID>AJ54UCHNM</merchant_ID>
<merchant_name>SafeMed Store, Inc.</merchant_name>
<merchant_type>medical</merchant_type>

</merchant>
<bill_type>recurring</bill_type>
<bill_freq>monthly</bill_freq>
<autopay_params>

<autopay_status>on</autopay_status>
<autopay_amount>fixed 50.00</autopay_amount>
<autopay_card>1234567890123456</autopay_card>
<expiry>2012-04-01</expiry>
<CVV>123</CVV>
<autopay_notify>on</autopay_notify>
<notify_address> john.q.public@dbp.com</notify_address>

</autopay_params>
<payment_methods>

<bill_pay_script>http://www.dbp.com/users/john.q.public/scripts
/Q438CBRE8.bps</bill_pay_script>
<phone_pay>1-800-172-4612#1#7223#4#$$$#1#2</phone_pay>
<phone_pay_autodial>on</phone_pay_autodial>
<manual_URL>http://www.merchant.com/user/billpay/</manual_URL>

</payment_methods>
<amount_due>88.56</amount_due>
<due_date>2011-04-01</due_date>
<pay_status>partial</pay_status>
<pay_amount>50.00</pay_amount>
<pay_date>2011-01-30</pay_date>
<pay_confirmation>23RUBF33ZZ</pay_confirmation>

</bill>

In some implementations, the app may provide the user options to pay the bill by activating element(s) within the interface, e.g., 238a-b. For example, the app may provide a user interface element which the user may activate to pay the bill over the Internet and/or other network (e.g., 238a), an element which the user may activate to pay the bill over a phone call (e.g., 238b). As discussed further below, in various implementations, the DBP may automate the procedure for paying a bill over the Internet and/or other network, paying a bill via phone, etc.

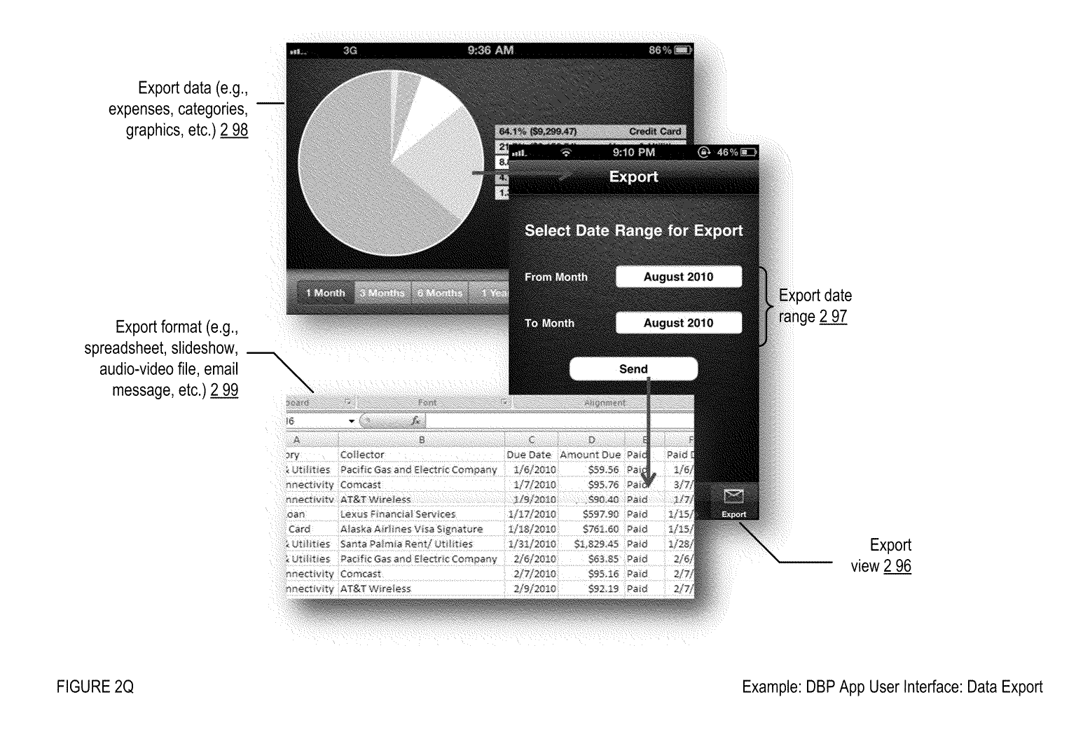

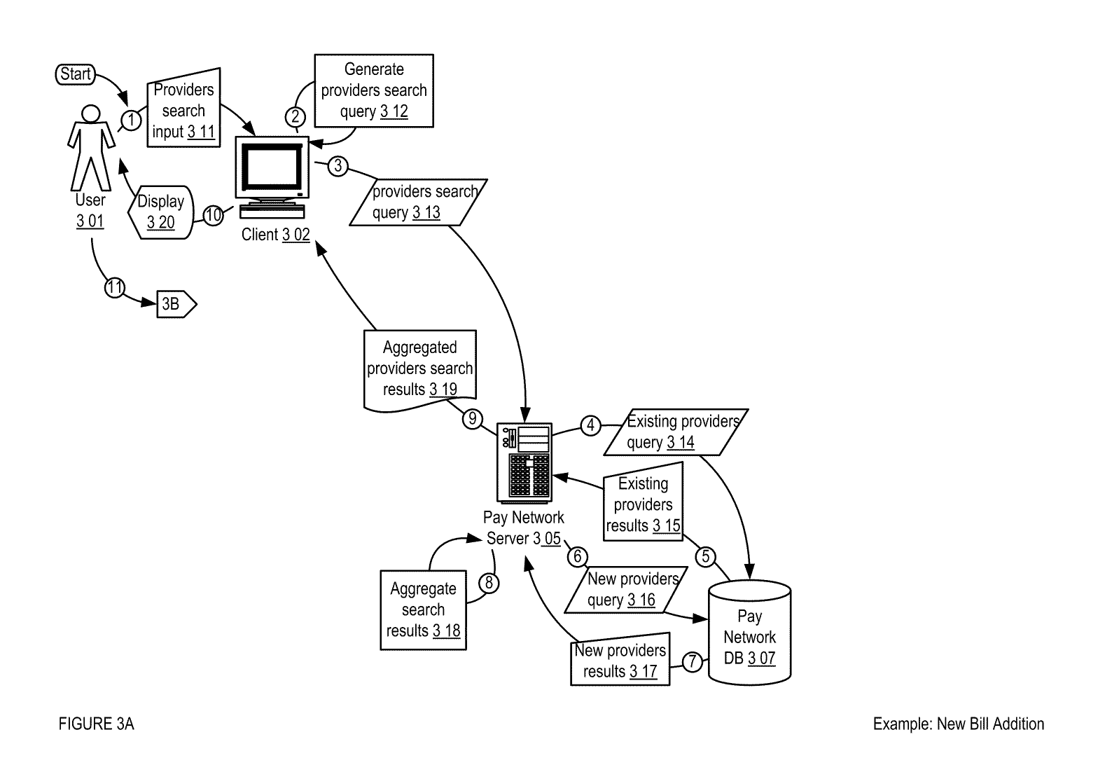

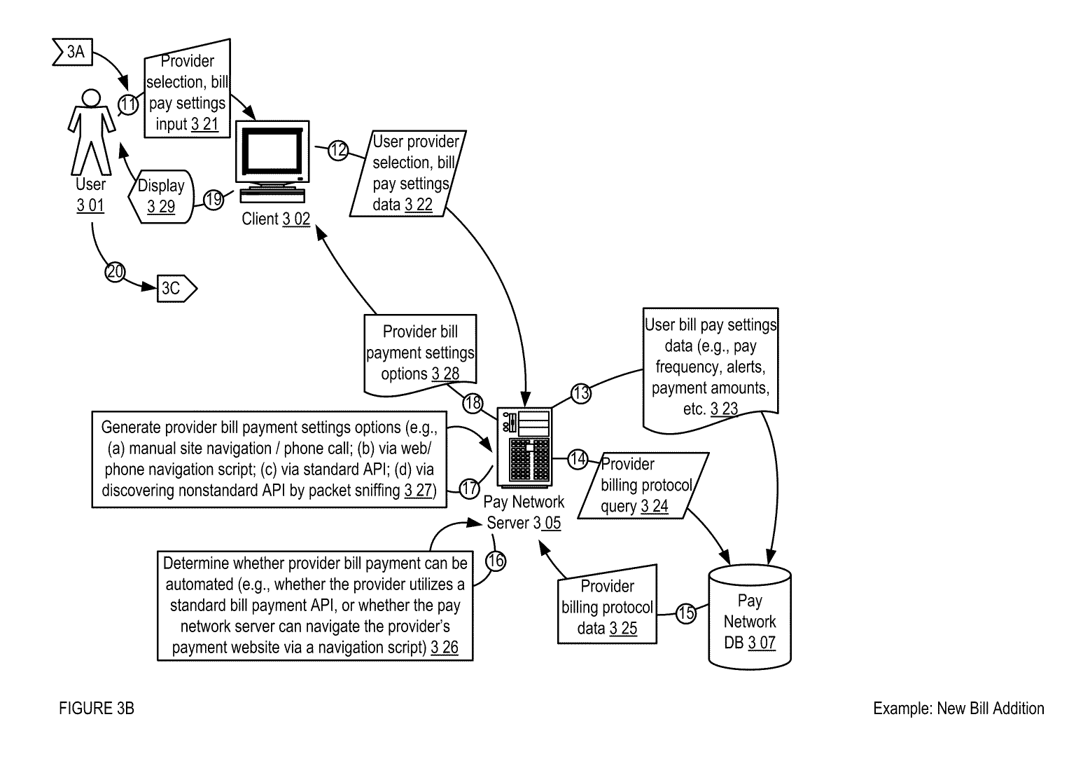

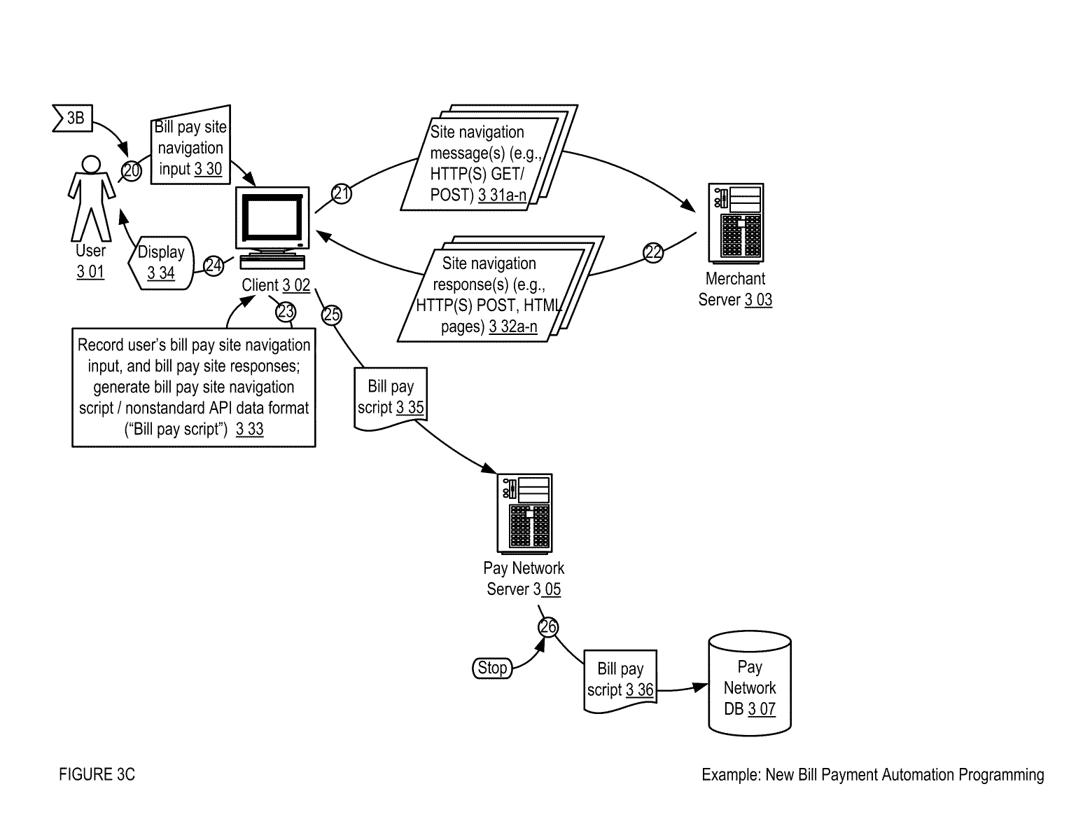

With reference to FIG. 2F, in some implementations, the user may activate an element, e.g., 238a (FIG. 2E), to make a bill payment over a network connection. In some such implementations, the user device may instantiate a browser window, and may navigate to a Uniform Resource Locator (“URL”), e.g., 241, of a bill pay site of the merchant associated with the user bill. For example, the user device may use the URL provided in the <manual_URL> tag in the example XML bill data structure provided above to navigate a web browser (sub-)module/application executing on the user device, e.g., 240, to a bill pay site of the merchant associated with the user bill. In some implementations, the user may manually navigate, e.g., 242, through the site upon the browser landing at the bill pay site of the merchant to pay the user bill. In alternate implementations, the app may utilize a bill pay script to automate navigation, see e.g., 242, of the browser through the merchant's bill pay site to pay the bill. For example, the app may utilize the bill pay script located at the address (e.g., URL, local memory address/file) identified in the <bill_pay_script> tag in the example XML bill data structure presented above to navigate through the merchant's bill pay site, as described below in further detail at least with reference to FIG. 3C. In some implementations, the app may provide elements which the user may activate to return to the previous view, after completion of bill payment (e.g., 243), or after canceling payment of the bill (e.g., 244).

With reference to FIG. 2G, in some implementations, the app may provide the user with a calendar view of the aggregated bills of the user. For example, the user may activate an element within the app interface (e.g., 245). In response, the app may present the user with the calendar view of the aggregated bills of the user. In some implementations, the app may provide a user interface element which the user may activate to select a date range, e.g., date range selector 246. For example, upon selection of a date range within the bills view when the calendar view is selected, the app may present a calendar indicating the dates within the date range on which bills are due or have been paid. In some implementations, presence of a bill due or paid on a specific date may be represented within the app interface graphically and/or in text. For example, the presence of a bill may be indicated, e.g., 247, by the date having text of a different color, or having a graphical (e.g., triangular) element within a cell element corresponding to the date on which the bill is due or has been paid. In some implementations, the user may select a category of bills (e.g., paid, unpaid, uncategorized, see bill category selector 248) for the app to display in the calendar view. In some implementations, a user may select one of the cells corresponding to a date within the calendar view, e.g., 249. In response, the app interface may present, e.g., 250, details of the user bills corresponding to the user-selected date.

With reference to FIG. 2H, in some implementations, a user may wish to add a new bill to the aggregated user bills. For example, the user may sign up for a new offering by a merchant, and may desire to utilize the app to pay bills for the new offering. For example, the user may add another bill from an existing merchant, or add a new merchant, e.g., 251. The user may activate a user interface element, such as “Add a new bill” button 213 (FIG. 2B) to add a new account from an existing or new merchant to the app interface. In some implementations, the app may provide user interface elements to add a new service provider/merchant, e.g., 252, and/or interface elements (such as a scrollable list) to select from existing service providers/merchants, e.g., 253. For example, the user may select an existing service provider/merchant, e.g., 254, from the app interface. With reference to FIG. 2I, in some implementations, the app may provide an interface where the user may input details about the bill the user wishes to add to the app. For example, the user may provide bill details such as the fields included in the example XML bill data structure described above with reference to FIG. 2E. For example, the user may provide a bill payment date (e.g., 255), using a bill payment date selector user interface element (e.g., 256). The user may provide a bill recurrence type, e.g., 257, a bill auto-pay flag, e.g., 258, and bill payment amount, e.g., 259, via various user interface elements.

With reference to FIG. 2J, in some implementations, the user may desire to add a new account using a search for existing and new merchants. For example, the user may input search terms into a search box element within an accounts view, e.g., 260, within the app user interface, e.g., 261. The app may search through the user's existing accounts, and display the search results for the user. For example, the app may provide the search results in the form of providers sorted by categories, e.g., 262. In some implementations, the user may include search terms that trigger the app to search for new merchants, and/or merchants based on the location of the user. For example, the user may enter a zipcode as a search term, which may trigger the app to search for merchants within the user-specified zipcode. In some implementations, the app may search for merchants based on the current location of the user, e,g., 263, using a GPS position associated with a user device of the user. The app may return search results comprising existing and new merchants for the user to select from. With reference to FIG. 2K, in some implementations, the app may return search results, e.g., grouped by category (see e.g., 265), upon the user performing a search for merchants by entering search terms, e.g., 264, into a search box in the app interface. The user may select one of the merchants from the returned search results, e.g., 266. In response, the app may provide input fields for the user to enter details about the user's account with the merchant. For example, the user may enter input fields similar to the merchant-related fields in the example XML bill data structure provided above in the discussion with reference to FIG. 2E. For example, the user may data such as, but not limited to: provider name (e.g., provider name field 267), service type (e.g., 268), user account number (e.g., 269), user service detail (e.g., 270), provider contact information (e.g., 271), miscellaneous information (e.g., 272), and/or the like. Using the information provided by the user, the app may generate a bill data structure, e.g., similar to the XML bill data structure provided above in the discussion with reference to FIG. 2E.

With reference to FIG. 2L, in some implementations, the app may provide spending reports for the user based on the user paying bills for various merchants via the app. For example, the user may select a reports view within the app (e.g., by activating the reports view 273 user interface element), and may select a date range for which the user desires the expense report (e.g., using the report date range selector 274 user interface element). In response, the app may provide the total expenditure for the date range (e.g., 275), as well as a category-wise breakdown of the expenses, e.g., 277. For example, the app may provide a listing of the categories, e.g., 276, and expense amounts associated with each category. In some implementations, the user may activate a user interface element to send the report (e.g., 278, via electronic mail, text message, Short Messaging Service, streaming audio/video, voicemail, etc.) to users and/or other entities and/or components of the DBP. With reference to FIG. 2M, in some implementations, the app may provide a device-orientation dependent report presentation, e.g., 284. For example, when the device is rotated to be a generally orthogonal compared to its prior position, the app may modify the presentation to provide additional (or fewer) user interface elements for the user to interact with. For example, the app may provide an enhanced date range selector, e.g., 279, a more detailed textual summary report, e.g., 280, a category-wise graphical breakdown of the user's expenses 281, expense categories, and associated expense amounts (e.g., 282-283), and/or the like. In some implementations, the app may provide the user a user interface element to send the report to users and/or other entities and/or components of the DBP. With reference to FIG. 2N, in some implementations, the user may select one of the user interface elements representing a category of user expenses (see e.g., 282) for detailed viewing. In response the app may provide an expense category detail view, e.g., 285. The detail view may include a listing of expense items, e.g., 288, providing descriptions of each of the expense items, e.g., 287, and expense amounts, e.g., 286, associated with each of the expense items.

With reference to FIG. 2O, in some implementations, the app may provide targeted advertisements to the user on merchants, service, providers, vendors, offerings, discounts, card issuing banks, other card issuers, etc. based on the user's past and/or current search queries, and/or the user's current and/or past location. For example, the app may determine “local” advertisements that are likely to be of interest to the user based on the user's expense categories, the user's search history, and/or the user's location profile. In some implementations, the app may provide the advertisements, e.g., 289, in the interface so that a user may select the advertisement to initiate signing up for the offering provided by the merchant, and addition of the offering from the merchant to the app. For example, the user may select the advertisement, and the app may provide the user with an interface (e.g., a web browser interface) where the user may sign up for the offering advertised. For example, on the user completing the sign up for the offering, the app may automatically add the account and/or the bills corresponding to the account to the app. In some implementations, the app may provide the user with user interface elements, e.g., 290, to scroll through numerous advertisements that the app determines are relevant to the user, and select the advertisements of the offerings that interest the user.

With reference to FIG. 2P, in some implementations, the user may select various app settings to enhance the user experience and customize the user's interaction experience with the app. For example, the user may select a settings view by activating a user interface element (e.g., 291). In response, the app may provide a settings view for the user, including fields such as, but not limited to: alert notification frequency 292 (e.g., for bills due, overdue, paid, expense reports, advertisements, etc.), alert flag 293 (e.g., whether the user would prefer alerts of a certain type), notification time (e.g., 294), and/or the like. In some implementations, the user may secure access to the app by settings a passcode for preventing unauthorized access to the user's expense and/or other financial information, e.g., 295. With reference to FIG. 2Q, in some implementations, an authorized user may export such user financial information, e.g., 298, by selecting an export view within the app, e.g., by selecting a user interface element such as export view element 296. In some implementations, the user may export financial information in the form of raw data, slide presentations, .mp3 audio, Adobe® Flash object, WebM video, QuickTime™ movie self-contained executable, etc (see e.g., 299). For example, the user may select an expense date range for export, e.g., 297, and may obtain the user bill information for the selected date range (e.g., paid bills, overdue bills, bills due), as well as information on merchant accounts, card accounts, merchant advertisements etc.

FIGS. 3A-C show data flow diagrams illustrating an example procedure to add a new user bill from a merchant, vendor, service provider and/or the like, and program automated recurring bill payment of the new user bill in some embodiments of the DBP. In some implementations, a user, e.g., 301, may wish to add an account with a merchant, vendor, service provider and/or the like (“provider”) providing an offering for the user to the user's app. The user may communicate with a pay network server, e.g., 305, via a client such as, but not limited to: a personal computer, mobile device, television, point-of-sale terminal, kiosk, ATM, and/or the like (e.g., 302). For example, the user may provide user input, e.g., providers search input 311, into the client indicating the user's desire to search for providers. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. In some implementations, the client may generate a search providers query, e.g., 312, and provide, e.g., 313, the generated search providers query to the pay network server. For example, a browser application executing on the client may provide, on behalf of the user, a (Secure) Hypertext Transfer Protocol (“HTTP(S)”) GET message including the providers search terms for the pay network server in the form of data formatted according to the eXtensible Markup Language (“XML”). Below is an example HTTP(S) GET message including an XML-formatted search providers query for the pay network server:

GET /billpayapp.php HTTP/1.1
Host: www.paynetwork.com
Content-Type: Application/XML
Content-Length: 1306
<?XML version = “1.0” encoding = “UTF-8”?>
<providers_search>

<request_ID>4NFU4RG94</order_ID>
<timestamp>2011-03-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>
<GPS>

<lat>47.285625</lat>
<lon>−123.395763</lon>
<timestamp>2011-03-22:15:22:33</timestamp>

</GPS>

</client_details>
<parameters>

<location>on</location>
<phrase>electricity OR water OR gas</phrase>

</parameters>

</providers_search>

In some implementations, the pay network server may obtain the search providers query from the client, and may parse the search providers query to extract details of the providers search requirements. The pay network server may generate queries for a database based on the extracted details of the search providers query obtained from the client. For example, a database, e.g., pay network database 307, may store details of merchants including fields such as, but not limited to: merchant_ID, merchant_name, merchant_location, merchant_category, merchant_rating, and/or the like. For example, the database may be a relational database responsive to Structured Query Language (“SQL”) commands. The pay network server may execute a hypertext preprocessor (“PHP”) script including SQL commands to query the database for details of merchants matching the search criteria of the user. For example, the pay network server may query the database for existing merchants of the user to find merchants matching the search criteria of the user. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“MERCHANTS.SQL”); // select database table to
search
//create query for issuer server data
$query = “SELECT merchant_name_merchant_address
merchant_id_merchant_url FROM

Merchantable WHERE user_id LIKE ′%′ $usereid” AND keyword
LIKE ‘%’ $keyphrase;

$result = mysql_query($query); // perform the search query
mysql_close(“MERCHANTS.SQL”); // close database access
?>

In response to obtaining the pay network server's query, e.g., 314, the pay network database may provide, e.g., 315, the requested search results comprising existing merchants of the user satisfying the search criteria provided by the user. In some implementations, the pay network server may query the database for merchants with whom the user does not have an account to find merchants matching the search criteria of the user. For example, the pay network server may execute a hypertext preprocessor (“PHP”) script including SQL commands similar to those presented above to query the database, e.g., 316, for details of merchants matching the search criteria of the user. In response to obtaining the pay network server's query, e.g., 316, the pay network database may provide, e.g., 317, the requested search results comprising merchants with whom the user does not have an account and satisfying the search criteria provided by the user. In some implementations, the pay network server may aggregate the search results from the search queries, e.g., 318, and provide the aggregated search results, e.g., 319, to the client. For example, the pay network server may provide a HTTP(S) POST message similar to the example message provided below:

POST /client.php HTTP/1.1
Host: 128.95.46.123
Content-Type: Application/XML
Content-Length: 1306
<?XML version = “1.0” encoding = “UTF-8”?>
<providers_results>

<request_ID>4NFU4RG94</order_ID>
<timestamp>2011-03-22 15:23:43</timestamp>
<user_ID>john.q.public@gmail.com</user_ID>
<parameters>

<location>on</location>
<phrase>electricity OR water OR gas</phrase>

</parameters>
<results>

<merchant>

<id>19838hd</id>
<name>merchant 1</name>
<URL>http://www.merchant1.com</URL>

</merchant>
<merchant>

<id>neid332</id>
<name>merchant 2</name>
<URL>http://www.merchant2.com</URL>

</merchant>

</results>

</providers_results>

The client may render the search results provided by the pay network server, and present, e.g., 320, the aggregated search results for the user. In some implementations, the user may provide a selection of a merchant from the aggregated search results to add to the user app. In some implementations, the user may also provide bill pay settings, e.g., 321, such as the example bill pay settings discussed above with reference to FIGS. 2A-Q. In various implementations, the user input may include, but not be limited to: mouse clicks, depressing buttons on a joystick/game console, voice commands, single/multi-touch gestures on a touch-sensitive interface, touching user interface elements on a touch-sensitive display, and/or the like. In response, the client may provide the provider bill payment settings options and the user selection of the merchant to the pay network server, e.g., 322. For example, the client may provide an XML-encoded bill data structure such as described above with reference to FIG. 2E via a HTTP(S) POST message similar to the example above. The pay network server may parse the user bill pay settings data, and store the user bill pay settings data in a database, e.g., 323.

In some implementations, the pay network server may attempt to determine whether bill payments to the merchant selected by the user may be automated. For example, in some implementations, the merchant may have a standardized method for making automated payments to the merchant. For example, the merchant may utilize an application programming interface (API) which utilizes a standard data format for payments made to the merchant. In some implementations, the server may query a database, e.g., pay network database 307, for a provider billing protocol. For example, the pay network server may utilize PHP/SQL commands similar to the example provided above. In response to the pay network server's provider billing protocol query, e.g., 324, the database may provide the provider billing protocol data, e.g., 325. The pay network server may determine whether provider bill payment can be automated, e.g., whether the provider utilizes a standard bill payment API, or whether the pay network server can navigate the provider's payment website via a navigation script (e.g., 326). Based on the determination, the pay network server may generate provider bill payment settings options (e.g., (a) manual site navigation/phone call; (b) via web/phone navigation script; (c) via standard API; (d) via discovering nonstandard API by packet sniffing), e.g., 327, according to which the user may make bill payments to the merchant. The pay network server may provide, e.g., 328, the provider bill payment settings options to the client. The client may render the provider bill payment settings options and present, e.g., 329, the provider bill payment settings option for the user.

In some implementations, the user may elect to generated a bill pay script to automate the payment of bills with the merchant, e.g., via an API used by the merchant, via a standard data structure (e.g., message body within a HTTP(S) POST message), via an automated web navigation script, and/or the like. In some implementations, the user may provide bill pay site navigation input to navigate the bill payment website of the merchant, e.g., 330. In various implementations, the user input may include, but not be limited to: mouse clicks, depressing buttons on a joystick/game console, voice commands, single/multi-touch gestures on a touch-sensitive interface, touching user interface elements on a touch-sensitive display, and/or the like. The client may record the user's bill pay site navigation input, and bill pay site responses to generate a bill pay site navigation script/nonstandard API data format (“bill pay script”), e.g., 333. The client may provide, based on the user's site navigation input, site navigation message(s) (e.g., HTTP(S) GET/POST messages, etc.) for the merchant server, e.g., 331a-n, hosting the merchant's pill payment website. The merchant server may provide response(s), e.g., 332a-n to the client-provided site navigation messages, which may include, e.g., HTTP(S) POST messages, HTML content, audio-visual media content, and/or the like. The client may record the user's bill pay site navigation input, and bill pay site responses to generate a bill pay site navigation script/nonstandard API data format (“bill pay script”), e.g., 333. Using the recordings, the client may generate an automation bill pay script. An example XML-encoded automation bill pay script to login with as username and password, submit a payment, store a payment receipt, and logoff, is provided below:

<bill_pay_script>

<goto>https://www.billpay.com/providerid/</goto>
<load>servercontent:timeout:60sec</load>
<select>frame2</select>
<input><form>username</form><value>john.q.public</value></input>
<input><form>password</form><value>johnspasscode</value></input>
<buttonclick>login_submit</buttonclick>
<load>servercontent:tiomeout:60sec</load>
<select>frame1</select>
<input><form>amount</form><value>#payvalue#</value></input>
<checkbox>agreeterms</checkbox>
<buttonclick>submit_payment</buttonclick>
<load>servercontent:tiomeout:60sec</load>
<store><value>receipt</receipt><content>loadcontent</content></store>
<select>frame3</select>
<buttonclick>logoff</buttonclick>
<return>receipt</return>

</bill_pay_script>

The client may provide the bill pay script, e.g., 335, to the pay network server. The pay network server may store the bill pay script corresponding to paying the user's bill with the merchant, in a database, e.g., pay network database 307. It is to be understood that in various alternate implementations, any actions discussed herein attributed to the user and/or client may be performed by the pay network server and/or other entities and/or DBP components, and vice versa.

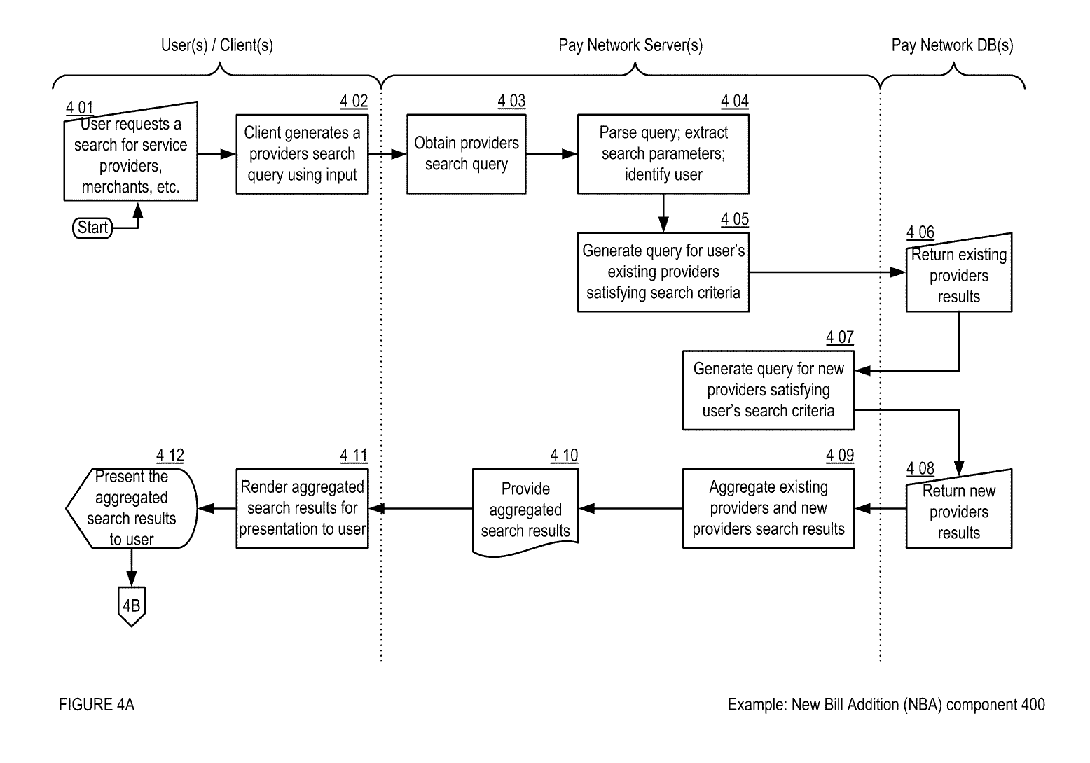

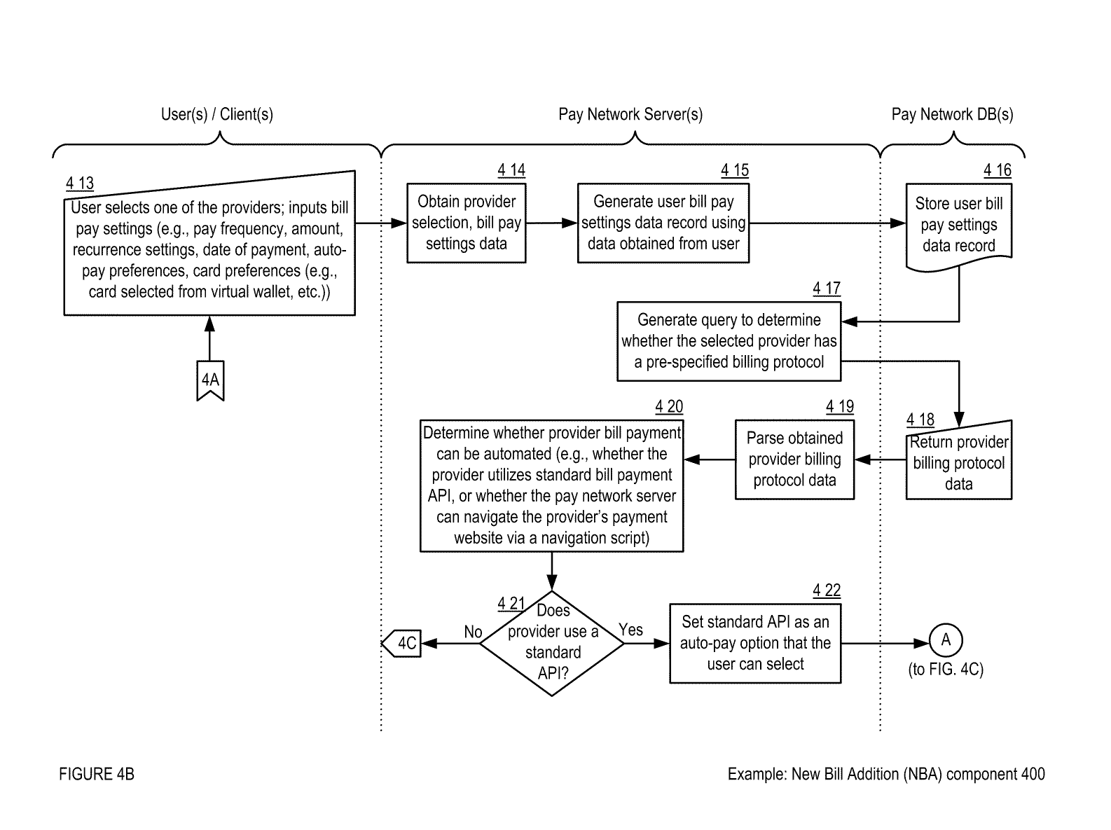

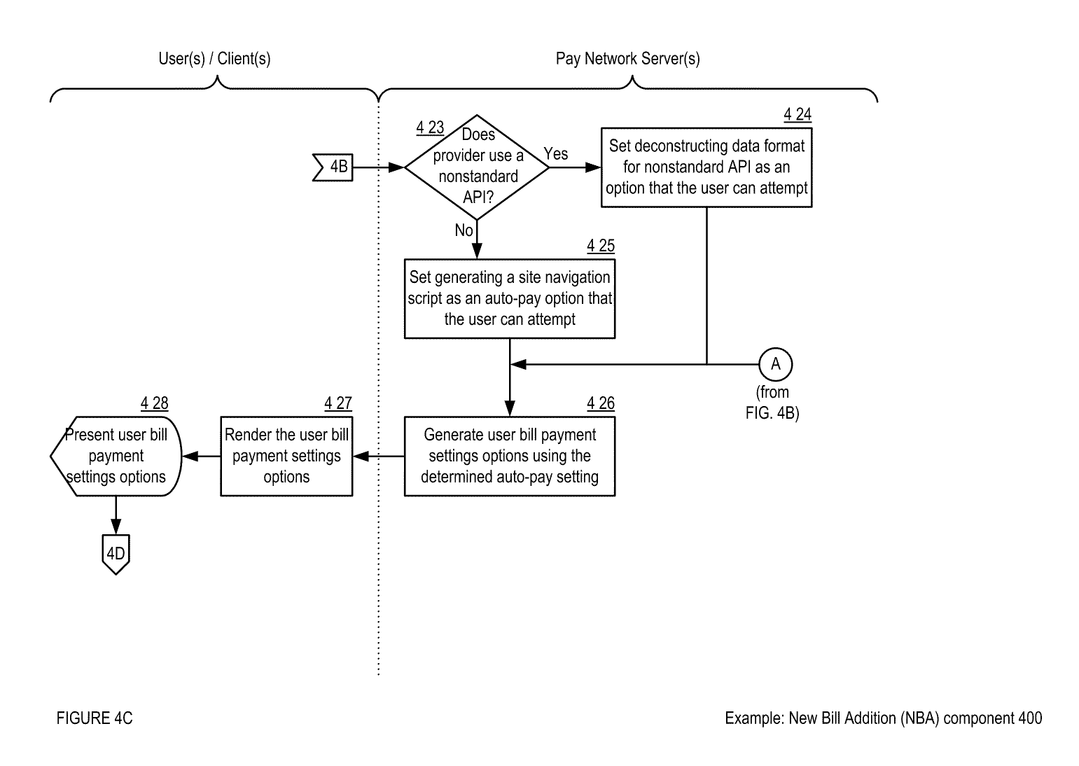

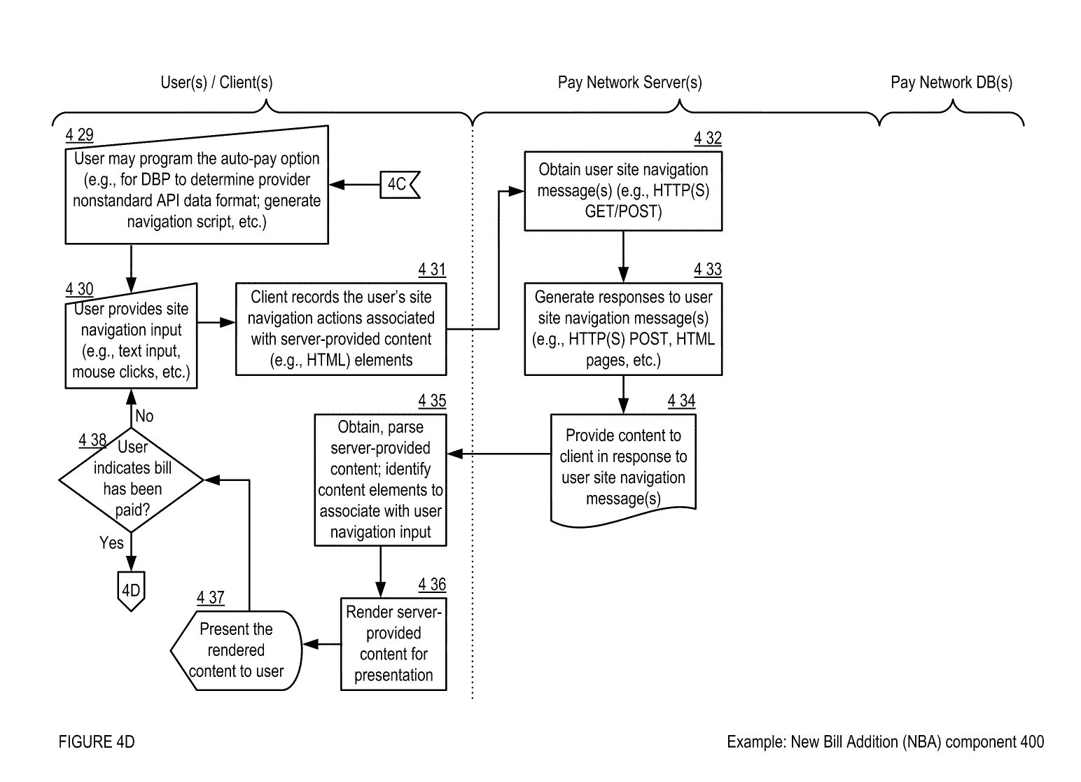

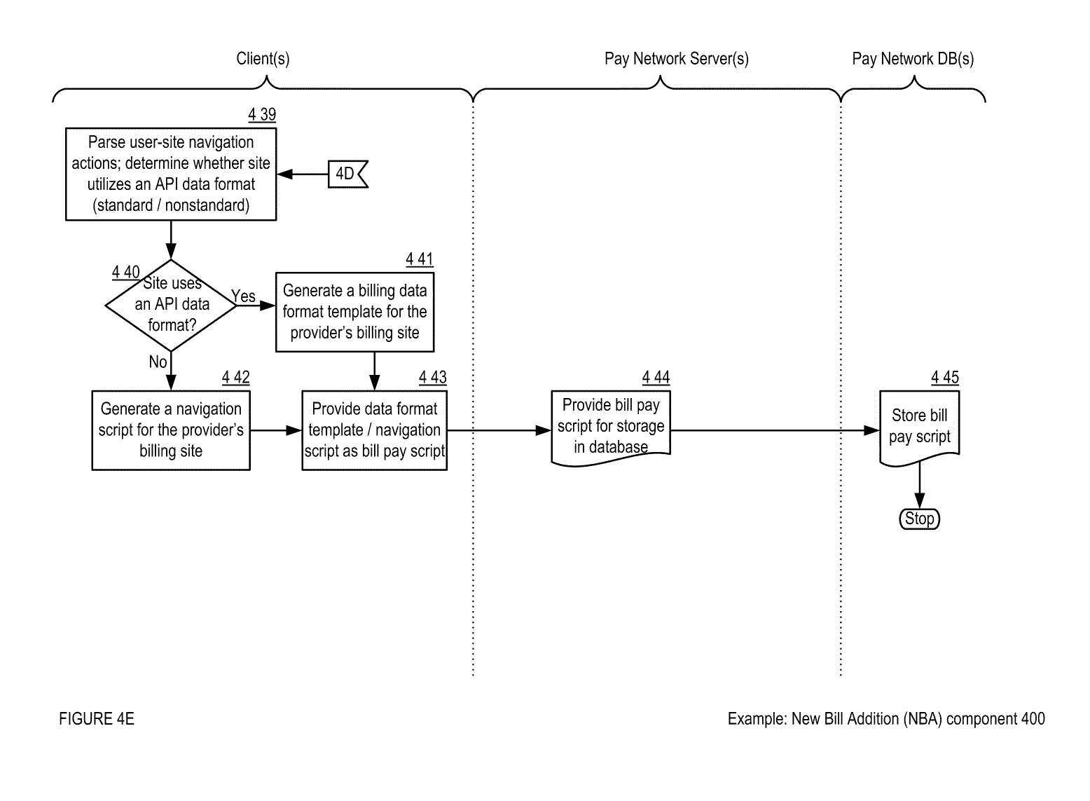

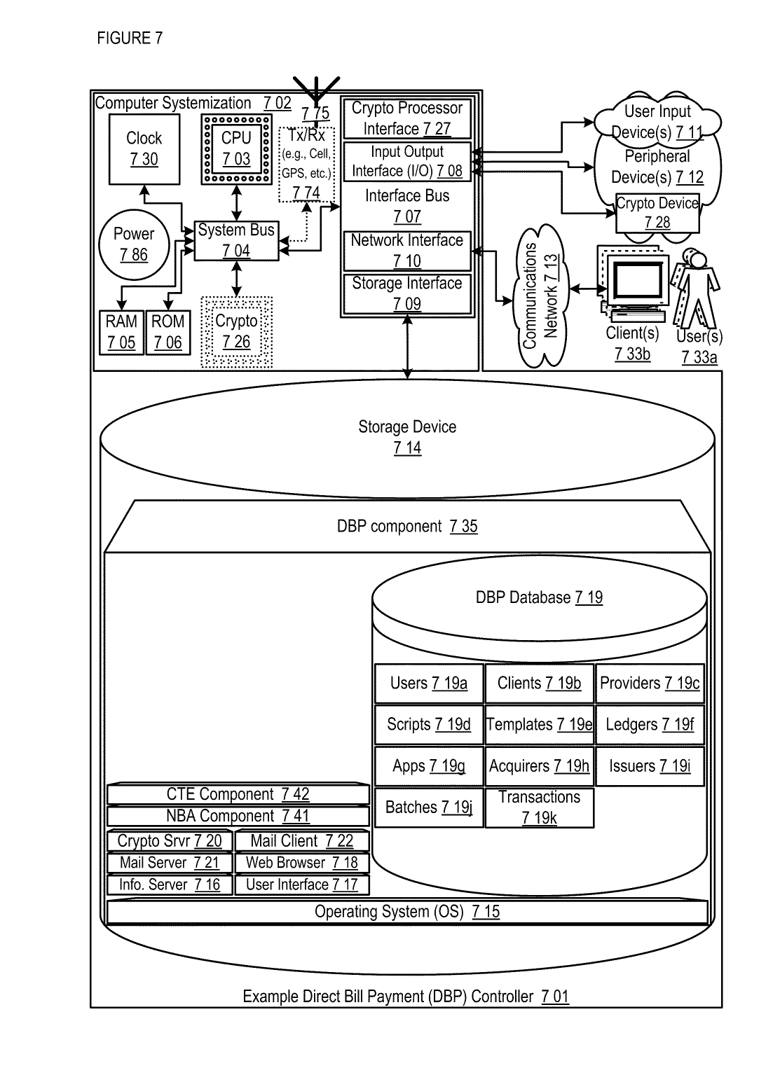

FIGS. 4A-E show logic flow diagrams illustrating example aspects of adding a new user bill from a merchant, vendor, service provider and/or the like, and programming automated recurring bill payment of the new user bill in some embodiments of the DBP, e.g., a New Bill Addition (“NBA”) component 400. In some implementations, a user may wish to add an account with a merchant, vendor, service provider and/or the like (“provider”) providing an offering for the user to the user's app. The user may provide user input, e.g., 401, into the client indicating the user's desire to search for providers. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. In some implementations, the client may generate a search providers query, e.g., 402, and provide the generated search providers query to the pay network server. The pay network server may obtain the search providers query from the client, e.g., 403, and may parse the search providers query to extract details of the providers search requirements, e.g., 404, as well as a user ID of the user. Example parsers that the pay network server may use are described further below in the discussion with reference to FIG. 7.

The pay network server may generate queries for a database based on the extracted details of the search providers query obtained from the client, e.g., 405. For example, a database, e.g., a pay network database, may store details of merchants including fields such as, but not limited to: merchant_ID, merchant_name, merchant_location, merchant_category, merchant_rating, and/or the like. The pay network server may query the database for existing merchants of the user to find merchants matching the search criteria of the user. In response to obtaining the pay network server's query, e.g., 405, the pay network database may provide, e.g., 406, the requested search results comprising existing merchants of the user satisfying the search criteria provided by the user. In some implementations, the pay network server may query, e.g., 407, the database for merchants with whom the user does not have an account to find merchants matching the search criteria of the user. In response to obtaining the pay network server's query, e.g., 407, the pay network database may provide, e.g., 408, the requested search results comprising merchants with whom the user does not have an account and satisfying the search criteria provided by the user. In some implementations, the pay network server may aggregate the search results from the search queries, e.g., 409, and provide the aggregated search results, e.g., 410, to the client. The client may render, e.g., 411, (e.g., via a browser application, the user app, etc.) the search results provided by the pay network server, and present, e.g., 412, the aggregated search results for the user.

In some implementations, the user may provide a selection of a merchant from the aggregated search results to add to the user app. In some implementations, the user may also provide bill pay settings, e.g., 413, such as the example bill pay settings discussed above with reference to FIGS. 2A-Q. The client may provide the provider bill payment settings options and the user selection of the merchant to the pay network server, e.g., 414. The pay network server may parse the user bill pay settings data, and generate a data record for storing the user bill pay settings data in a database, e.g., 415. The pay network server may provide the generated user bill pay settings data record and the database may store the data record, e.g., 416. In some implementations, the pay network server may attempt to determine whether bill payments to the merchant selected by the user may be automated. For example, in some implementations, the merchant may have a standardized method for making automated payments to the merchant. For example, the merchant may utilize an application programming interface (API) which utilizes a standard data format for payments made to the merchant. In some implementations, the server may query a database, e.g., 417, for a provider billing protocol. In response to the pay network server's provider billing protocol query, e.g., 417, the database may provide the provider billing protocol data, e.g., 418. The pay network server may parse the obtained provider billing protocol data, e.g., 419. Based on the parsing of the provider billing protocol data, the pay network server may determine whether provider bill payment can be automated, e.g., whether the provider utilizes a standard bill payment API, or whether the pay network server can navigate the provider's payment website via a navigation script (e.g., 420). If the pay network server determines that the provider uses a standard API for accepting bill payment (e.g., 421, option “Yes”), the pay network server may set the standard API as an auto-=pay option that the user can select in the app interface as an automated method for paying bills associated with the provider. If the provider does not use a standard API, e.g., 421, option “No,” the pay network server may determine whether the provider uses a nonstandard API interface for accepting bill payments, e.g., 423. If the provider does accept bill payments via a nonstandard API, e.g., 423, option “No,” the pay network server may give the user an option to command the server deconstruct the data format used by the nonstandard API to facilitate automated bill payments. If the provider does not accept bill payments via any API, e.g., 423, option “No,” the pay network server pa set generating an automated site navigation script as an auto-pay option that the user can attempt, e.g., 425. Using the determined options that the server can present to the user for automated bill payment, the pay network server may generate user bill payment settings options (e.g., for presentation within the app settings view in the app executing on the user device). The pay network server may provide the user bill payment settings options to the client (e.g., (a) manual site navigation/phone call; (b) via web/phone navigation script; (c) via standard API; (d) via discovering nonstandard API by packet sniffing). The client may render, e.g., 427, the user bill payment settings options, e.g., 427, and provide the user bill payment settings options for presentation to the user, e.g., 428.

In some implementations, the user may elect to generated a bill pay script to automate the payment of bills with the merchant, e.g., via an API used by the merchant, via a standard data structure (e.g., message body within a HTTP(S) POST message), via an automated web navigation script, and/or the like, e.g., 429. In some implementations, the user may provide bill pay site navigation input to navigate the bill payment website of the merchant, e.g., 430. The client may record, e.g., 431 the user's bill pay site navigation input, and bill pay site responses to generate a bill pay site navigation script/nonstandard API data format (“bill pay script”). For example, the client may associate user input actions with the content elements present in the content provided by the server. The client may provide, based on the user's site navigation input, site navigation message(s) (e.g., HTTP(S) GET/POST messages, etc.) for the merchant server, e.g., 432, hosting the merchant's pill payment website. The merchant server may generate, e.g., 433, and provide response(s), e.g., 434, to the client-provided site navigation messages that may include, e.g., HTTP(S) POST messages, HTML content, audio-visual media content, and/or the like. The client may obtain the content provided by the server, and may parse, e.g., 435, the server-provided content to identify content elements (e.g., HTML tags, input fields, security pass-phrases, etc.) within the server-provided content. The client may render, e.g., 436, the server provided content, e.g., 434, and provide the rendered content for presentation to the user, e.g., 437. In some implementations, the user may indicate completion of navigation of the provider bill payment site, e.g., so that the user has completed payment of the bill via navigation of the site, e.g., 438, option “Yes.”. This may trigger the pay network server to stop the recording of user action and/or server-provided content. Thus, the pay network server may be able to generate an auto-navigation bill pay script that may guide a client or server on actions to take to mimic the user's navigation of the provider bill pay site.

In some implementations, the client may determine whether the site utilizes an API data format (e.g., standard or nonstandard API), e.g., 439. If the site uses an API, e.g., 440, option “Yes,” the client may generate a billing data format template associated with the provider's billing site, e.g., 441. If the site does not user any API data format, e.g., 440, option “No,” then the automation may be determined to be enabled only by the auto-navigation bill pay script. In such implementations, the client may generate the auto-navigation bill pay script that may guide a client or server on actions to take to mimic the user's navigation of the provider bill pay site, e.g., 442. The client may save the data format template and/or the auto-navigation bill pay script as the “bill pay script” for automation of the user's bill payments for the provider, e.g. 443, and provide the bill pay script for server-side storage and/or use. The pay network server may provide, e.g., 444, the bill pay script obtained from the client for storage in a database, e.g., 445. It is to be understood that in various alternate implementations, any actions discussed herein attributed to the user and/or client may be performed by the pay network server and/or other entities and/or DBP components, and vice versa.

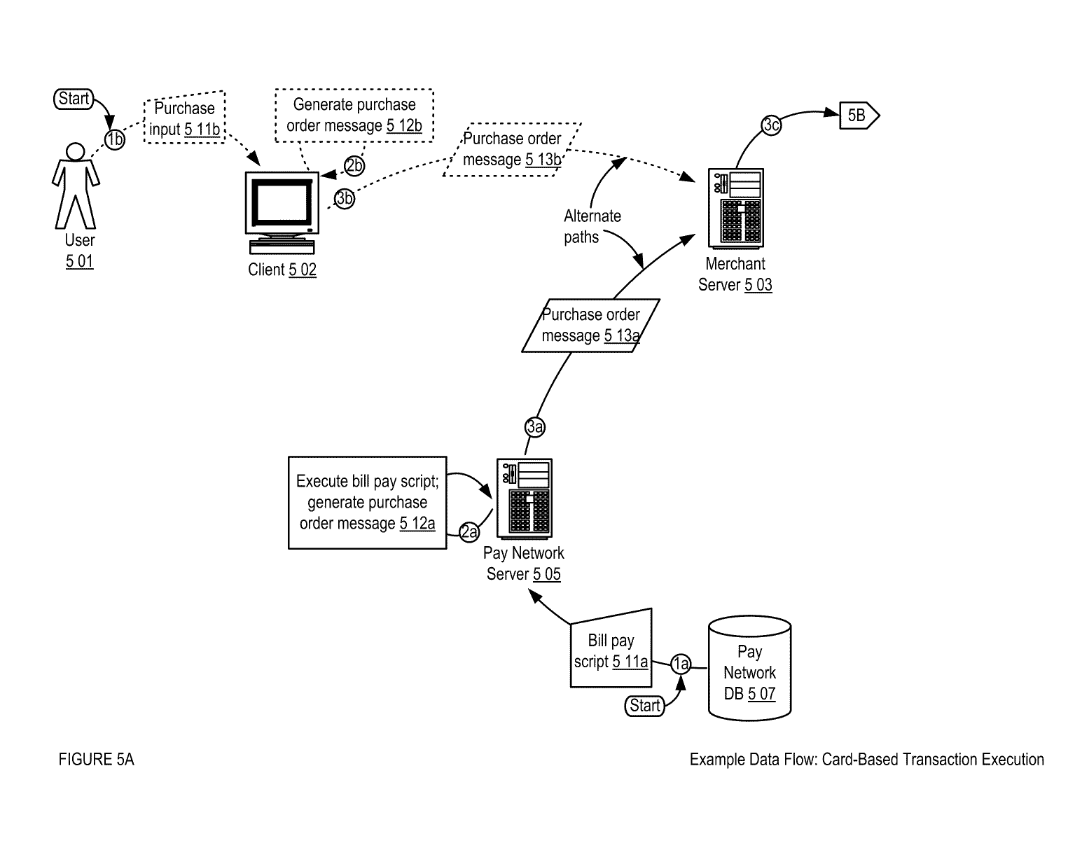

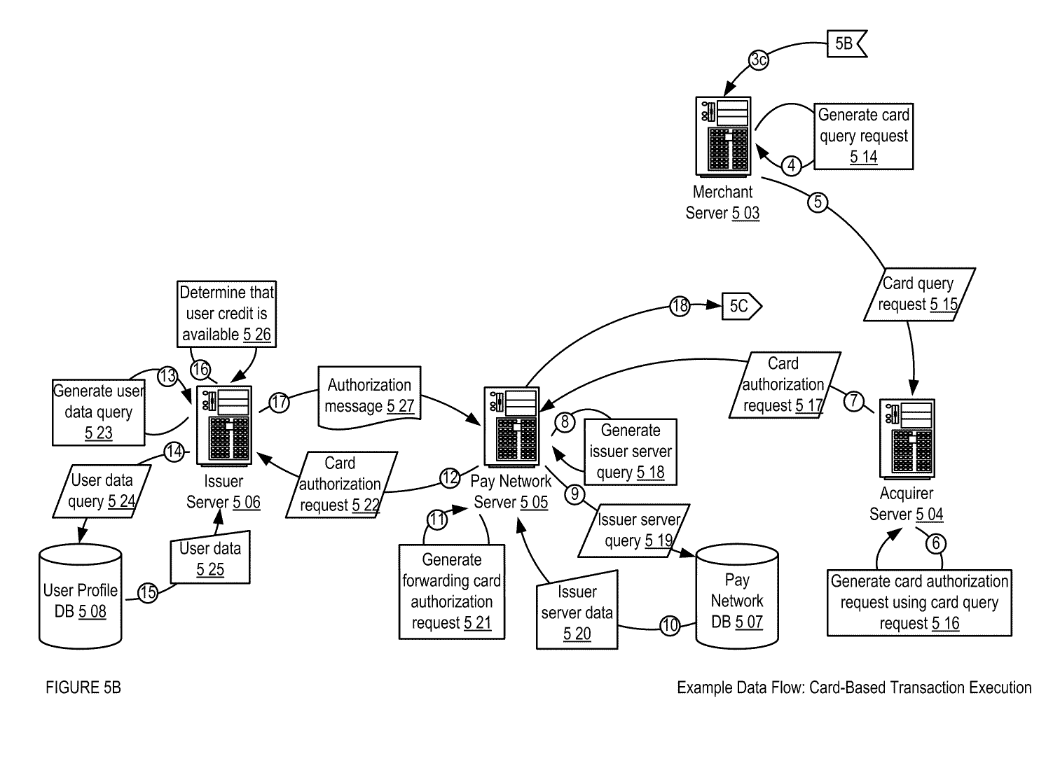

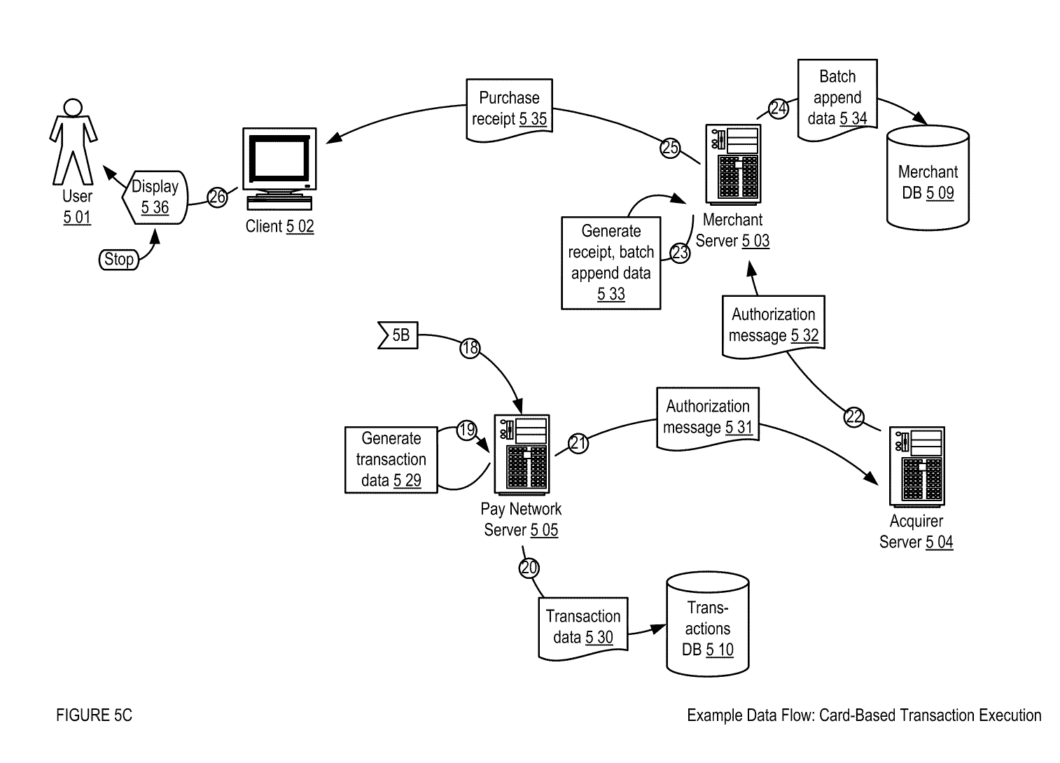

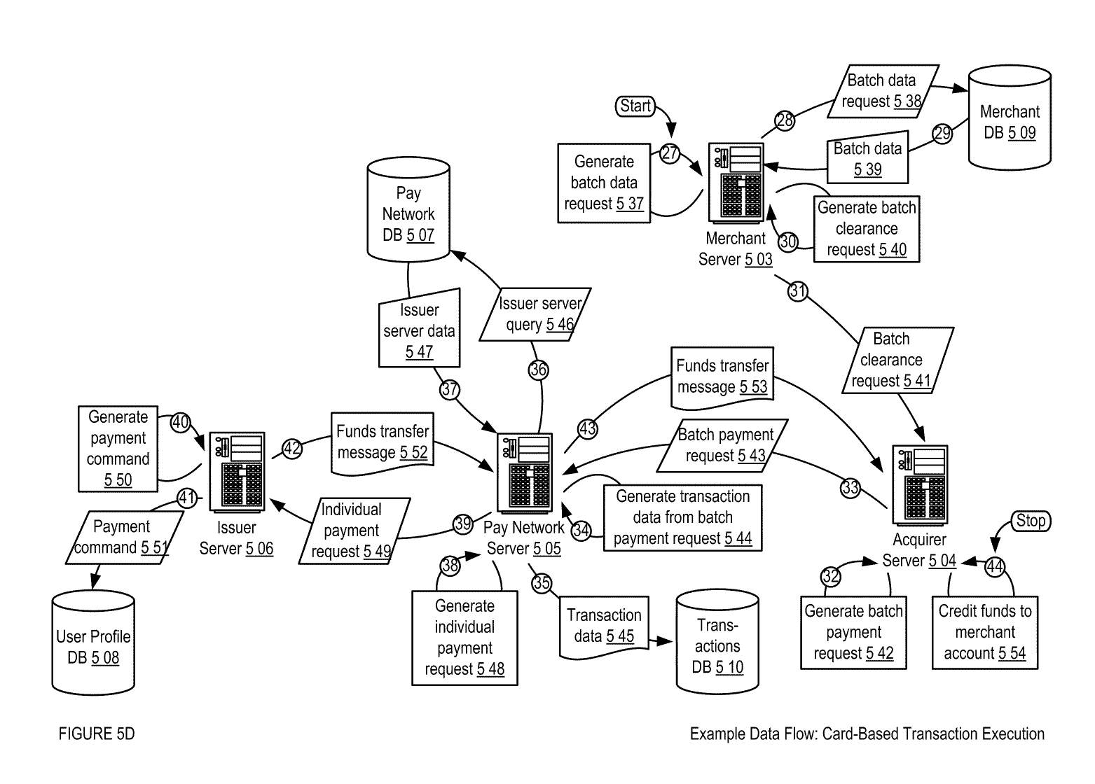

FIGS. 5A-D show data flow diagrams illustrating an example procedure to execute a card-based transaction to pay an outstanding user bill expense due to a merchant in some embodiments of the DBP. In some implementations, a pay network server, e.g., 505, may retrieve from a database, e.g., pay network database 507, a bill pay script, e.g., 511a. In various implementations, the pay network server may be triggered by various events to retrieve the bill pay script and execute automated bill payment. As one example, a user 501 may communicate with the pay network server via a client device, e.g., 502. For example, the user may instruct the pay network server to perform automated bill payment by utilizing a bill pay script. For example, the user may utilize a user app such as the example app illustrated in FIGS. 2A-Q. For example, the user may activate a “Launch to pay” graphical user interface element (e.g., pay via network connection 238a) in the client app. In response, the client app may communicate with the pay network server to trigger the pay network server to utilize a bill pay script to execute bill payment for an outstanding bill from the merchant.

In some implementations, the bill pay script may represent a recording of the actions of a user, e.g., 501, used to pay an outstanding bill of the user via a website of a merchant, such as the example presented above in the discussion with reference to FIG. 3C. Thus, in some implementations, the pay network server may be able to re-create exactly the actions of the user while navigating the bill payment website of the merchant, and thereby mimic (in an automated fashion) the user's manual payment of a bill outstanding from the merchant. For example, the pay network server may execute, e.g., 512a, the bill pay script. The pay network server may obtain webpage(s) from the merchant server, and may navigate through the webpage(s) by providing input into the webpage(s) according to the instructions provided in the bill pay script. For example, the pay network server may parse the bill pay script, and identify that the script requires the server to input a data value into an input element within content page(s) (e.g. an <input> tag element within a HTML form) provided by the merchant server 503. The pay network server may then enter the appropriate data value in an automated fashion into the input element. In some implementations, the pay network server may navigate through the bill payment site until the pay network server executes all of the instructions included in the bill pay script. In some implementations, the execution of the instructions included in the bill pay script may result in the pay network server generating a purchase order message, e.g., 513a, such as the example XML-encoded purchase order message described further below. The pay network server may provide the generated purchase order message to the merchant server for automated recurring bill payment.

In some implementations, a user, e.g., 501, may desire to manually pay a bill related to a product, service, offering, and/or the like (“product”), from a merchant. The user may communicate with a merchant server, e.g., 503, via a client such as, but not limited to: a personal computer, mobile device, television, point-of-sale terminal, kiosk, ATM, and/or the like (e.g., 502). For example, the user may provide user input, e.g., purchase input 511b, into the client indicating the user's desire to pay a bill related to purchase of the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may utilize a user app executing on the client, and may activate a user interface element such as the “pay via network connection” 238a user interface element illustrated in FIG. 2E. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a purchase order message, e.g., 512b, and provide, e.g., 513b, the generated purchase order message to the merchant server, e.g., 503. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for
dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. The merchant server may generate a card query request, e.g., 514, to determine whether the transaction can be processed. For example, the merchant server may attempt to determine whether the user has sufficient funds to pay for the purchase in a card account provided with the purchase order. The merchant server may provide the generated card query request, e.g., 515, to an acquirer server, e.g., 504. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

POST /cardquery.php HTTP/1.1
Host: www.acquirer.com
Content-Type: Application/XML
Content-Length: 624
<?XML version = “1.0” encoding = ”UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for dummies</product_summary>
<product_quantity>1</product_quantity?

</product>

</purchase_summary>
<transaction_cost>$34.78</transaction_cost>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</card_query_request>

In some implementations, the acquirer server may generate a card authorization request, e.g., 516, using the obtained card query request, and provide the card authorization request, e.g., 517, to a pay network server, e.g., 505. For example, the acquirer server may redirect the HTTP(S) POST message in the example above from the merchant server to the pay network server.

In some implementations, the pay network server may obtain the card authorization request from the acquirer server, and may parse the card authorization request to extract details of the request. Using the extracted fields and field values, the pay network server may generate a query, e.g., 518, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 506, of the issuer may maintain details of the user's card account. In some implementations, a database, e.g., pay network database 507, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address

auth_key port_num security_settings_list FROM IssuerTable
WHERE account_num
LIKE ′%′ $accountnum”;

$result = mysql_query($query); // perform the search query
mysql_close(“ISSUERS.SQL”); // close database access
?>

In response to obtaining the issuer server query, e.g., 519, the pay network database may provide, e.g., 520, the requested issuer server data to the pay network server. In some implementations, the pay network server may utilize the issuer server data to generate a forwarding card authorization request, e.g., 521, to redirect the card authorization request from the acquirer server to the issuer server. The pay network server may provide the card authorization request, e.g., 522, to the issuer server. In some implementations, the issuer server, e.g., 506, may parse the card authorization request, and based on the request details may query a database, e.g., user profile database 508, for data of the user's card account. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type FROM
UserTable

WHERE account_num LIKE ′%′ $accountnum”;

$result = mysql_query($query); // perform the search query
mysql_close(“USERS.SQL”); // close database access
?>

In some implementations, on obtaining the user data, e.g., 525, the issuer server may determine whether the user can pay for the transaction using funds available in the account, e.g., 526. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 527, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record, e.g., 529, from the card authorization request it received, and store, e.g., 530, the details of the transaction and authorization relating to the transaction in a database, e.g., transactions database 510. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access database server
mysql_select(″TRANSACTIONS.SQL″); // select database to append
mysql_query(“INSERT INTO PurchasesTable (timestamp, purchase_summary_list,

num_products, product_summary, product_quantity, transaction_cost,
account_params_list, account_name, account_type, account_num,
billing_addres, zipcode, phone, sign, merchant_params_list, merchant_id,
merchant_name, merchant_auth_key)

VALUES (time( ), $purchase_summary_list, $num_products, $product_summary,

$product_quantity, $transaction_cost, $account_params_list, $account_name,
$account_type, $account_num, $billing_addres, $zipcode, $phone, $sign,
$merchant_params_list, $merchant_id, $merchant_name, $merchant_auth_key)”);
// add data to table in database

mysql_close(″TRANSACTIONS.SQL″); // close connection to database
?>

In some implementations, the pay network server may forward the authorization message, e.g., 531, to the acquirer server, which may in turn forward the authorization message, e.g., 532, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 533, and store the XML data file, e.g., 234, in a database, e.g., merchant database 509. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some implementations, the server may also generate a purchase receipt, e.g., 533, and provide the purchase receipt to the client. The client may render and display, e.g., 536, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 5D, in some implementations, the merchant server may initiate clearance of a batch of authorized transactions. For example, the merchant server may generate a batch data request, e.g., 537, and provide the request, e.g., 538, to a database, e.g., merchant database 509. For example, the merchant server may utilize PHP/SQL commands similar to the examples provided above to query a relational database. In response to the batch data request, the database may provide the requested batch data, e.g., 539. The server may generate a batch clearance request, e.g., 540, using the batch data obtained from the database, and provide, e.g., 541, the batch clearance request to an acquirer server, e.g., 504. For example, the merchant server may provide a HTTP(S) POST message including XML-formatted batch data in the message body for the acquirer server. The acquirer server may generate, e.g., 542, a batch payment request using the obtained batch clearance request, and provide the batch payment request to the pay network server, e.g., 543. The pay network server may parse the batch payment request, and extract the transaction data for each transaction stored in the batch payment request, e.g., 544. The pay network server may store the transaction data, e.g., 545, for each transaction in a database, e.g., transactions database 510. For each extracted transaction, the pay network server may query, e.g., 546, a database, e.g., pay network database 507, for an address of an issuer server. For example, the pay network server may utilize PHP/SQL commands similar to the examples provided above. The pay network server may generate an individual payment request, e.g., 548, for each transaction for which it has extracted transaction data, and provide the individual payment request, e.g., 549, to the issuer server, e.g., 506. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>K/product_quantity?

</product>

</purchase_summary>

</pay_request>

In some implementations, the issuer server may generate a payment command, e.g., 550. For example, the issuer server may issue a command to deduct funds from the user's account (or add a charge to the user's credit card account). The issuer server may issue a payment command, e.g., 551, to a database storing the user's account information, e.g., user profile database 508. The issuer server may provide a funds transfer message, e.g., 552, to the pay network server, which may forward, e.g., 553, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 554.

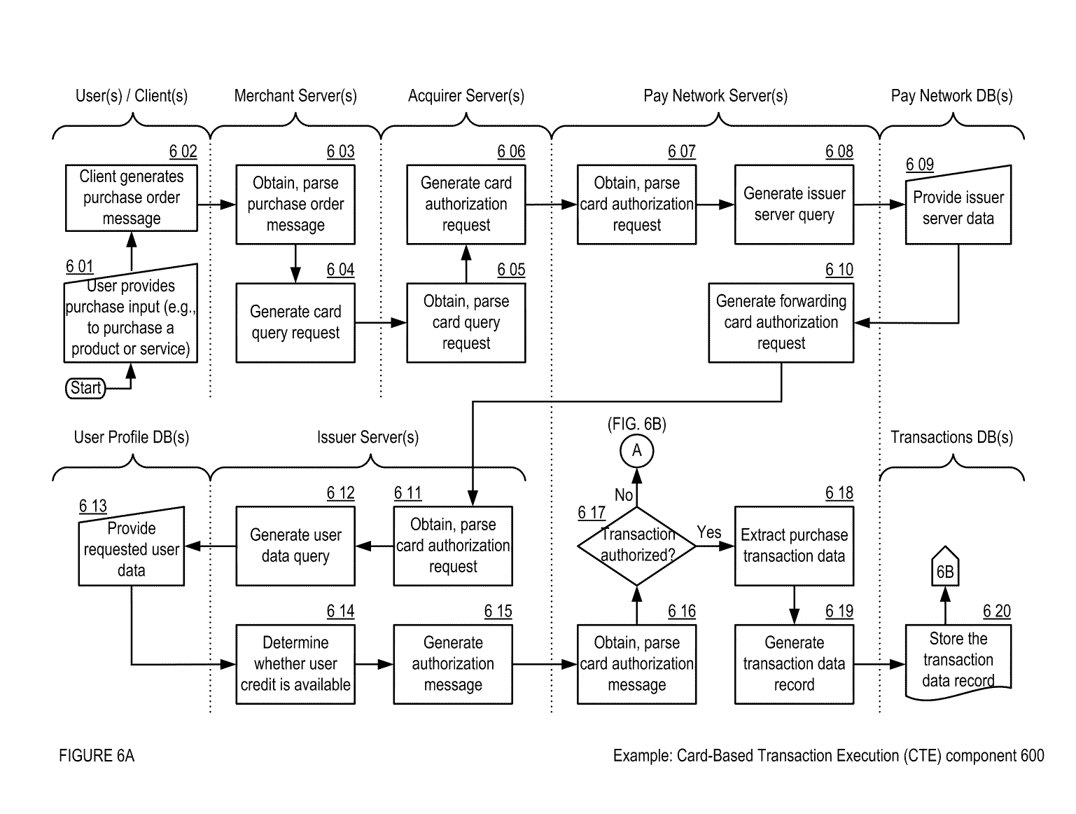

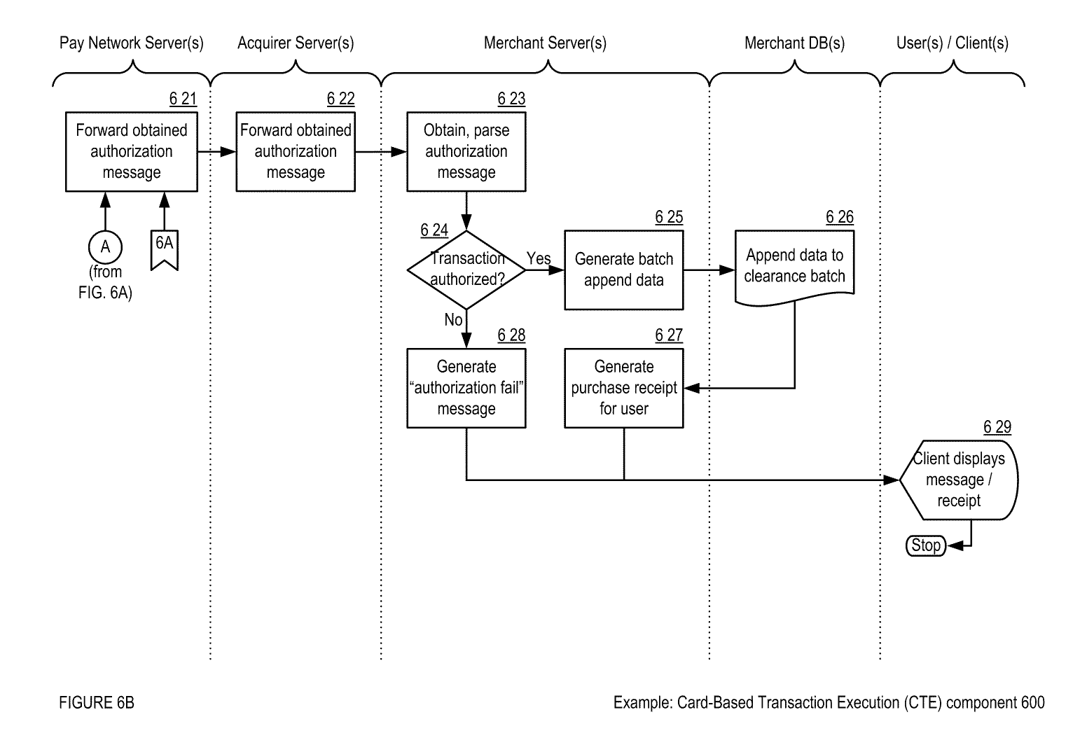

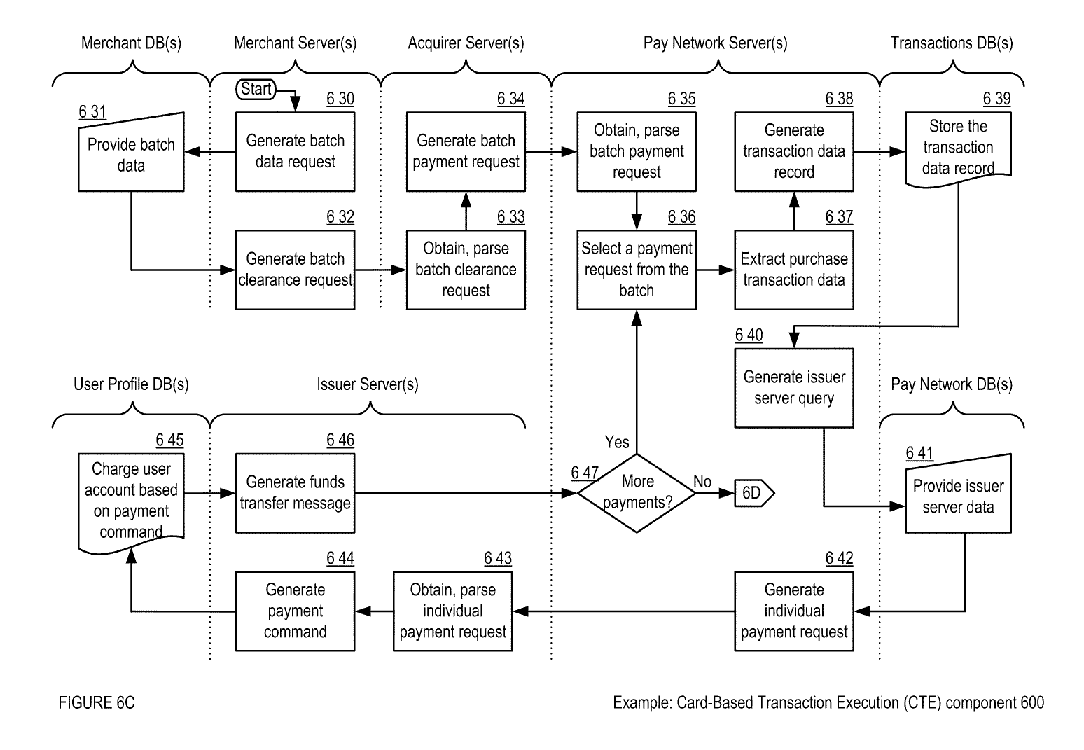

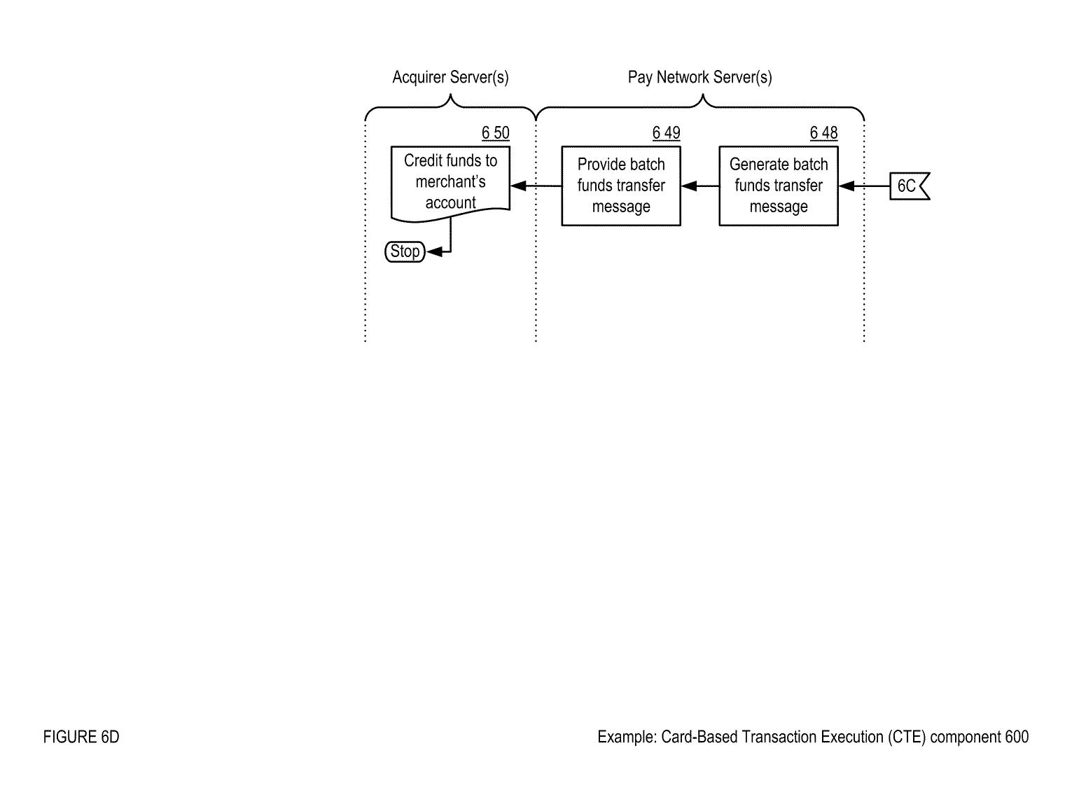

FIGS. 6A-D show logic flow diagrams illustrating example aspects of executing a card-based transaction to pay an outstanding user bill expense due to a merchant in some embodiments of the DBP, e.g., a Card-Based Transaction Execution (“CTE”) component 600. In some implementations, a user may provide user input, e.g., 601, into a client indicating the user's desire to purchase a product from a merchant. The client may generate a purchase order message, e.g., 602, and provide the generated purchase order message to the merchant server. In alternate implementations, a pay network server may retrieve from a bill pay script from a database. The pay network server may execute the bill pay script and thereby execute automated bill payment. As part of execution of the pay script, the pay network server may generate a purchase order message similar to the purchase order message generated by a client in alternate implementations.

Thus, in some implementations, the merchant server may obtain, e.g., 603, the purchase order message from the client and/or pay network server, and may parse the purchase order message to extract details of the purchase order. Example parsers that the merchant client may utilize are discussed further below with reference to FIG. 7. The merchant server may generate a card query request, e.g., 604, to determine whether the transaction can be processed. For example, the merchant server may process the transaction only if the user has sufficient funds to pay for the purchase in a card account provided with the purchase order. The merchant server may provide the generated card query request to an acquirer server. The acquirer server may generate a card authorization request, e.g., 606, using the obtained card query request, and provide the card authorization request to a pay network server. In some implementations, the pay network server may obtain the card authorization request from the acquirer server, and may parse the card authorization request to extract details of the request. Using the extracted fields and field values, the pay network server may generate a query, e.g., 608, for an issuer server corresponding to the user's card account. In response to obtaining the issuer server query the pay network database may provide, e.g., 609, the requested issuer server data to the pay network server. In some implementations, the pay network server may utilize the issuer server data to generate a forwarding card authorization request, e.g., 610, to redirect the card authorization request from the acquirer server to the issuer server. The pay network server may provide the card authorization request to the issuer server. In some implementations, the issuer server may parse, e.g., 611, the card authorization request, and based on the request details may query a database, e.g., 612, for data of the user's card account. In response, the database may provide the requested user data. On obtaining the user data, e.g., 613, the issuer server may determine whether the user can pay for the transaction using funds available in the account, e.g., 614. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 615, to the pay network server.

In some implementations, the pay network server may obtain the authorization message, and parse, e.g., 616, the message to extract authorization details. Upon determining that the user possesses sufficient funds for the transaction (e.g., 617, option “Yes”), the pay network server may extract the transaction card from the authorization message and/or card authorization request, e.g., 618, and generate a transaction data record, e.g., 619, using the card transaction details. The pay network server may provide the transaction data record for storage, e.g., 620, to a database. In some implementations, the pay network server may forward the authorization message, e.g., 621, to the acquirer server, which may in turn forward the authorization message, e.g., 622, to the merchant server. The merchant may obtain the authorization message, and parse the authorization message o extract its contents, e.g., 623. The merchant server may determine whether the user possesses sufficient funds in the card account to conduct the transaction. If the merchant server determines that the user possess sufficient funds, e.g., 624, option “Yes,” the merchant server may add the record of the transaction for the user to a batch of transaction data relating to authorized transactions, e.g., 625. The merchant server may also generate a purchase receipt, e.g., 627, for the user. If the merchant server determines that the user does not possess sufficient funds, e.g., 624, option “No,” the merchant server may generate an “authorization fail” message, e.g., 628. The merchant server may provide the purchase receipt or the “authorization fail” message to the client. The client may render and display, e.g., 629, the purchase receipt for the user.

In some implementations, the merchant server may initiate clearance of a batch of authorized transactions by generating a batch data request, e.g., 630, and providing the request to a database. In response to the batch data request, the database may provide the requested batch data, e.g., 631, to the merchant server. The server may generate a batch clearance request, e.g., 632, using the batch data obtained from the database, and provide the batch clearance request to an acquirer server. The acquirer may obtain the batch clearance request from the merchant server, and parse, e.g., 633, the batch clearance request to extract details of the clearance request. The merchant server may generate, e.g., 634, a batch payment request using the obtained batch clearance request, and provide the batch payment request to a pay network server. The pay network server may parse, e.g., 635, the batch payment request, select a transaction stored within the batch data, e.g., 636, and extract the transaction data for the transaction stored in the batch payment request, e.g., 637. The pay network server may generate a transaction data record, e.g., 638, and store the transaction data, e.g., 639, the transaction in a database. For the extracted transaction, the pay network server may generate an issuer server query, e.g., 640, for an address of an issuer server maintaining the account of the user requesting the transaction. The pay network server may provide the query to a database. In response, the database may provide the issuer server data requested by the pay network server, e.g., 641. The pay network server may generate an individual payment request, e.g., 642, for the transaction for which it has extracted transaction data, and provide the individual payment request to the issuer server using the issuer server data from the database.

In some implementations, the issuer server may obtain the individual payment request, and parse, e.g., 643, the individual payment request to extract details of the request. Based on the extracted data, the issuer server may generate a payment command, e.g., 644. For example, the issuer server may issue a command to deduct funds from the user's account (or add a charge to the user's credit card account). The issuer server may issue a payment command, e.g., 645, to a database storing the user's account information. In response, the database may update a data record corresponding to the user's account to reflect the debit/charge made to the user's account. The issuer server may provide a funds transfer message, e.g., 646, to the pay network server after the payment command has been executed by the database.

In some implementations, the pay network server may check whether there are additional transactions in the batch that need to be cleared and funded. If there are additional transactions, e.g., 647, option “Yes,” the pay network server may process each transaction according to the procedure described above. The pay network server may generate, e.g., 648, an aggregated funds transfer message reflecting transfer of all transactions in the batch, and provide, e.g., 649, the funds transfer message to the acquirer server. The acquirer server may, in response, transfer the funds specified in the funds transfer message to an account of the merchant, e.g., 650.

### DBP Controller

FIG. 7 illustrates inventive aspects of a DBP controller 701 in a block diagram. In this embodiment, the DBP controller 701 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DBP controller 701 may be connected to and/or communicate with entities such as, but not limited to: one or more users from user input devices 711; peripheral devices 712; an optional cryptographic processor device 728; and/or a communications network 713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The DBP controller 701 may be based on computer systems that may comprise, but are not limited to, components such as: a computer systemization 702 connected to memory 729.

### Computer Systemization

A computer systemization 702 may comprise a clock 730, central processing unit (“CPU(s)” and/or “processor(s)” (these terms are used interchangeable throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother)board(s) 702 having conductive and/or otherwise transportive circuit pathways through which instructions (e.g., binary encoded signals) may travel to effect communications, operations, storage, etc. Optionally, the computer systemization may be connected to an internal power source 786; e.g., optionally the power source may be internal. Optionally, a cryptographic processor 726 and/or transceivers (e.g., ICs) 774 may be connected to the system bus. In another embodiment, the cryptographic processor and/or transceivers may be connected as either internal and/or external peripheral devices 712 via the interface bus I/O. In turn, the transceivers may be connected to antenna(s) 775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing DBP controller to determine its location)); Broadcom BCM4329FKUBG transceiver chip (e.g., providing 802.11n, Bluetooth 2.1+EDR, FM, etc.); a Broadcom BCM₄₇₅₀IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the DBP controller and beyond through various interfaces. Should processing requirements dictate a greater amount speed and/or capacity, distributed processors (e.g., Distributed DBP), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the DBP may be achieved by implementing a microcontroller such as CAST's R8051XC2 microcontroller; Intel's MCS 51 (i.e., 8051 microcontroller); and/or the like. Also, to implement certain features of the DBP, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DBP component collection (distributed or otherwise) and/or features may be implemented via the microprocessor and/or via embedded components; e.g., via ASIC, coprocessor, DSP, FPGA, and/or the like. Alternately, some implementations of the DBP may be implemented with embedded components that are configured and used to achieve a variety of features or signal processing.

Depending on the particular implementation, the embedded components may include software solutions, hardware solutions, and/or some combination of both hardware/software solutions. For example, DBP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the DBP features. A hierarchy of programmable interconnects allow logic blocks to be interconnected as needed by the DBP system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the DBP may be developed on regular FPGAs and then migrated into a fixed version that more resembles ASIC implementations. Alternate or coordinating implementations may migrate DBP controller features to a final ASIC instead of or in addition to FPGAs. Depending on the implementation all of the aforementioned embedded components and microprocessors may be considered the “CPU” and/or “processor” for the DBP.

### Power Source

The power source 786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the DBP thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

### Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the DBP controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed DBP), architectures may similarly be employed to pool, load balance, and/or otherwise increase the communicative bandwidth required by the DBP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 712 may be connected and/or communicate to I/O and/or other facilities of the like such as network interfaces, storage interfaces, directly to the interface bus, system bus, the CPU, and/or the like. Peripheral devices may be external, internal and/or part of the DBP controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the DBP controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the DBP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the DBP controller and/or a computer systemization may employ various forms of memory 729. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 729 may contain a collection of program and/or database components and/or data such as, but not limited to: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); the DBP component(s) 735; and/or the like (i.e., collectively a component collection). These components may be stored and accessed from the storage devices and/or from storage devices accessible through an interface bus. Although non-conventional program components such as those in the component collection, typically, are stored in a local storage device 714, they may also be loaded and/or stored in memory such as: peripheral devices, RAM, remote storage facilities through a communications network, ROM, various forms of memory, and/or the like.

### Operating System

The operating system component 715 is an executable program component facilitating the operation of the DBP controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the DBP controller to communicate with other entities through a communications network 713. Various communication protocols may be used by the DBP controller as a subcarrier transport mechanism for interaction, such as, but not limited to: multicast, TCP/IP, UDP, unicast, and/or the like.

### Information Server

An information server component 716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DBP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the DBP database 719, operating systems, other program components, user interfaces, Web browsers, and/or the like.

Access to the DBP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DBP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the DBP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/₇ (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the DBP enabled nodes. The combined application may be nugatory on systems employing standard Web browsers.

### Mail Server

A mail server component 721 is a stored program component that is executed by a CPU 703. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the DBP.

Access to the DBP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by a CPU 703, cryptographic processor 726, cryptographic processor interface 727, cryptographic processor device 728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the DBP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the DBP component to engage in secure transactions if so desired. The cryptographic component facilitates the secure accessing of resources on the DBP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The DBP Database

The DBP database component 719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DBP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the DBP database is implemented as a data-structure, the use of the DBP database 719 may be integrated into another component such as the DBP component 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 719 includes several tables 719a-k. A User table 719a may include fields such as, but not limited to: user_id, applicant_id, firstname, lastname, address_line1, address_line2, dob, ssn, credit_check_flag, zipcode, city, state, account_params_list, account_mode, account_type, account_expiry, preferred_bank_name, preferred_branch_name, credit_report, and/or the like. The User table may support and/or track multiple entity accounts on a DBP. A Clients table 719b may include fields such as, but not limited to: client_ID, client_type, client_MAC, client_IP, presentation_format, pixel_count, resolution, screen_size, audio_fidelity, hardware_settings_list, software_compatibilities_list, installed_apps_list, and/or the like. A Providers table 719c may include fields such as, but not limited to: provider_id, provider_name, provider_address, ip_address, mac_address, auth_key, port_num, security_settings_list, and/or the like. A Scripts table 719d may include fields such as, but not limited to: script_id, script_user, merchant_id, script_size, script_passcode, script_security_settings, script_commands_list, and/or the like. A Templates table 719e may include fields such as, but not limited to: bill_id, last_modified, user_id, client_params_list, client_id, client_IP, client_MAC, merchant_params_list, merchant_id, merchant_name, merchant_rtype, bill_type, bill_freq, autopay_params_list, autopay_status, autopay_amount, autopay_card, expiry, CVV, autopay_notify, notify_address, payment_methods_params_list, bill_pay_script, phone_pay, phone_pay_autodial, manual_URL, amount_due, due_date, pay_status, pay_amount, pay_date, pay_confirmation, and/or the like. A Ledgers table 719f may include fields such as, but not limited to: request_id, timestamp, deposit_amount, batch_id, transaction_id, clear_flag, deposit_account, transaction_summary, payor_name, payor_account, and/or the like. An Apps table 719g may include fields such as, but not limited to: app_ID, app_name, app_type, OS_compatibilities_list, version, timestamp, developer_ID, and/or the like. An Acquirers table 719h may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. An Issuers table 719i may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, issuer_id, issuer_name, issuer_address, ip_address, mac_address, auth_key, port_num, security_settings_list, and/or the like. A Batches table 719j may include fields such as, but not limited to: applicant_firstname, applicant_lastname, applicant_address_line1, applicant_address_line2, consumer_bureau_data_list, consumer_bureau_data, applicant_clear_flag, credit_limit, credit_score, account_balances, delinquency_flag, quality_flags, batch_id, transaction_id_list, timestamp_list, cleared_flag_list, clearance_trigger_settings, and/or the like. A Transactions table 719k may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like.

In one embodiment, the DBP database may interact with other database systems. For example, employing a distributed database system, queries and data access by search DBP component may treat the combination of the DBP database, an integrated data security layer database as a single database entity.

In one embodiment, user programs may contain various user interface primitives, which may serve to update the DBP. Also, various accounts may require custom database tables depending upon the environments and the types of clients the DBP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 719a-k. The DBP may be configured to keep track of various settings, inputs, and parameters via database controllers.

The DBP database may communicate to and/or with other components in a component collection, including itself, and/or facilities of the like. Most frequently, the DBP database communicates with the DBP component, other program components, and/or the like. The database may contain, retain, and provide information regarding other nodes and data.

### The DBPs

The DBP component 735 is a stored program component that is executed by a CPU. In one embodiment, the DBP component incorporates any and/or all combinations of the aspects of the DBP discussed in the previous figures. As such, the DBP affects accessing, obtaining and the provision of information, services, transactions, and/or the like across various communications networks.

The DBP component may transform location-specific providers search queries via DBP components into automated recurring bill notifications and payments, and/or the like and use of the DBP. In one embodiment, the DBP component 735 takes inputs (e.g., providers search input 311, existing providers results 315, new providers results 317, provider selection, bill pay settings input 321, provider billing protocol data 325, bill pay site navigation input 330, bill pay script 511, purchase input 511, issuer server data 520, user data 525, batch data 539, issuer server data 547, and/or the like) etc., and transforms the inputs via various components (e.g., NBA component 741, CTE component 742, and/or the like), into outputs (e.g., aggregated providers search results 319, user bill pay settings data 323, provider bill payment settings options 328, bill pay script 335, bill pay script 336, authorization message 527, authorization message 531, authorization message 532, batch append data 534, purchase receipt 535, transaction data 545, funds transfer message 552, funds transfer message 553, and/or the like).

The DBP component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the DBP server employs a cryptographic server to encrypt and decrypt communications. The DBP component may communicate to and/or with other components in a component collection, including itself, and/or facilities of the like. Most frequently, the DBP component communicates with the DBP database, operating systems, other program components, and/or the like. The DBP may contain, communicate, generate, obtain, and/or provide program component, system, user, and/or data communications, requests, and/or responses.

### Distributed DBPs

The structure and/or operation of any of the DBP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the DBP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the DBP controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference.

Non-limiting exemplary embodiments highlighting numerous further advantageous aspects include:
A1. A bill payment scripting processor-implemented method, comprising:

obtaining a request to add a user service bill to a user interface of a consolidated bill payment mobile application linked to a user card account;

recording user web interface actions to pay the user service bill using the user card account;

generating a pre-recorded web navigation automation script for payment of the user service bill based on the recording; and

providing a user interface element to the user interface of a consolidated bill payment mobile application that activates playback of the pre-recorded web navigation automation script for user bill payment.
A2. The method of embodiment Al, further comprising:

obtaining an indication to play back the pre-recorded web navigation script for payment of the user service bill;

parsing the pre-recorded web navigation script;

identifying a command included in the pre-recorded web navigation script; and

performing a web navigation action according to the identified command included in the pre-recorded web navigation script.
A3. The method of embodiment A2, wherein the indication to play back the pre-recoded web navigation script is provided by a user.
A4. The method of embodiment A2, further comprising:

obtaining a bill due date corresponding to a bill associated with the pre-recorded web navigation script;

comparing a current date with the obtained bill due date;

determining that a bill payment needs to be made based on comparing the bill due date with the current date; and

generating the indication to play back the pre-recorded web navigation script for payment of the user service bill.
A5. The method of embodiment A3, further comprising:

obtaining a bill due date corresponding to a bill associated with the pre-recorded web navigation script;

comparing a current date with the obtained bill due date;

determining that a bill payment needs to be made based on comparing the bill due date with the current date; and

providing an alert notification to the user indicating the bill due date corresponding to the bill associated with the pre-recorded web navigation script.
A6. The method of embodiment A5, further comprising:

providing, as part of the alert notification, the user interface element to the user interface of the consolidated bill payment mobile application that activates the playback of the pre-recorded web navigation automation script for user bill payment.
A7. The method of embodiment A2, further comprising:

generating a payment receipt notification after completion of user bill payment using the pre-recorded web navigation automation script; and

providing the generated payment receipt notification.
A8. The method of embodiment A7, further comprising:

modifying a visual attribute of a user interface element of the user interface of the consolidated bill payment mobile application after generating the payment receipt notification.
A9. A bill payment scripting apparatus, comprising:
a processor; and
a memory disposed in communication with the processor and storing processor-executable instructions to:

obtain a request to add a user service bill to a user interface of a consolidated bill payment mobile application linked to a user card account;

record user web interface actions to pay the user service bill using the user card account;

generate a pre-recorded web navigation automation script for payment of the user service bill based on the recording; and

provide a user interface element to the user interface of a consolidated bill payment mobile application that activates playback of the pre-recorded web navigation automation script for user bill payment.
A10. The apparatus of embodiment A9, the memory further storing instructions to:

obtain an indication to play back the pre-recorded web navigation script for payment of the user service bill;

parse the pre-recorded web navigation script;

identify a command included in the pre-recorded web navigation script; and

perform a web navigation action according to the identified command included in the pre-recorded web navigation script.
A11. The apparatus of embodiment A10, wherein the indication to play back the pre-recoded web navigation script is provided by a user.
A12. The apparatus of embodiment A10, the memory further storing instructions to:

obtain a bill due date corresponding to a bill associated with the pre-recorded web navigation script;

compare a current date with the obtained bill due date;

determine that a bill payment needs to be made based on comparing the bill due date with the current date; and

generate the indication to play back the pre-recorded web navigation script for payment of the user service bill.
A13. The apparatus of embodiment A11, the memory further storing instructions to:

obtain a bill due date corresponding to a bill associated with the pre-recorded web navigation script;

compare a current date with the obtained bill due date;

determine that a bill payment needs to be made based on comparing the bill due date with the current date; and

provide an alert notification to the user indicating the bill due date corresponding to the bill associated with the pre-recorded web navigation script.
A14. The system of embodiment A13, the memory further storing instructions to:

provide, as part of the alert notification, the user interface element to the user interface of the consolidated bill payment mobile application that activates the playback of the pre-recorded web navigation automation script for user bill payment.
A15. The system of embodiment A10, the memory further storing instructions to:

generate a payment receipt notification after completion of user bill payment using the pre-recorded web navigation automation script; and

provide the generated payment receipt notification.
A16. The system of embodiment A15, the memory further storing instructions to:

modify a visual attribute of a user interface element of the user interface of the consolidated bill payment mobile application after generating the payment receipt notification.
A17. A processor-readable tangible medium storing processor-executable bill payment scripting instructions to:

obtain a request to add a user service bill to a user interface of a consolidated bill payment mobile application linked to a user card account;

record user web interface actions to pay the user service bill using the user card account;

generate a pre-recorded web navigation automation script for payment of the user service bill based on the recording; and

provide a user interface element to the user interface of a consolidated bill payment mobile application that activates playback of the pre-recorded web navigation automation script for user bill payment.
A18. The medium of embodiment A17, further storing instructions to:

obtain an indication to play back the pre-recorded web navigation script for payment of the user service bill;

parse the pre-recorded web navigation script;

identify a command included in the pre-recorded web navigation script; and

perform a web navigation action according to the identified command included in the pre-recorded web navigation script.
A19. The medium of embodiment A18, wherein the indication to play back the pre-recoded web navigation script is provided by a user.
A20. The medium of embodiment A18, further storing instructions to:

obtain a bill due date corresponding to a bill associated with the pre-recorded web navigation script;

compare a current date with the obtained bill due date;

determine that a bill payment needs to be made based on comparing the bill due date with the current date; and

generate the indication to play back the pre-recorded web navigation script for payment of the user service bill.
A21. The medium of embodiment A19, further storing instructions to:

obtain a bill due date corresponding to a bill associated with the pre-recorded web navigation script;

compare a current date with the obtained bill due date;

determine that a bill payment needs to be made based on comparing the bill due date with the current date; and

provide an alert notification to the user indicating the bill due date corresponding to the bill associated with the pre-recorded web navigation script.
A22. The medium of embodiment A21, further storing instructions to:

provide, as part of the alert notification, the user interface element to the user interface of the consolidated bill payment mobile application that activates the playback of the pre-recorded web navigation automation script for user bill payment.
A23. The medium of embodiment A18, further storing instructions to:

generate a payment receipt notification after completion of user bill payment using the pre-recorded web navigation automation script; and

provide the generated payment receipt notification.
A24. The medium of embodiment A23, further storing instructions to:

modify a visual attribute of a user interface element of the user interface of the consolidated bill payment mobile application after generating the payment receipt notification.
A25. A bill payment scripting means, comprising:

means for obtaining a request to add a user service bill to a user interface of a consolidated bill payment mobile application linked to a user card account;

means for recording user web interface actions to pay the user service bill using the user card account;

means for generating a pre-recorded web navigation automation script for payment of the user service bill based on the recording; and

means for providing a user interface element to the user interface of a consolidated bill payment mobile application that activates playback of the pre-recorded web navigation automation script for user bill payment.
A26. The means of embodiment A25, further comprising:

means for obtaining an indication to play back the pre-recorded web navigation script for payment of the user service bill;

means for parsing the pre-recorded web navigation script;

means for identifying a command included in the pre-recorded web navigation script; and

means for performing a web navigation action according to the identified command included in the pre-recorded web navigation script.
A27. The means of embodiment A26, wherein the indication to play back the pre-recoded web navigation script is provided by a user.
A28. The means of embodiment A26, further comprising:

means for obtaining a bill due date corresponding to a bill associated with the pre-recorded web navigation script;

means for comparing a current date with the obtained bill due date;

means for determining that a bill payment needs to be made based on comparing the bill due date with the current date; and

means for generating the indication to play back the pre-recorded web navigation script for payment of the user service bill.
A29. The means of embodiment A27, further comprising:

means for obtaining a bill due date corresponding to a bill associated with the pre-recorded web navigation script;

means for comparing a current date with the obtained bill due date;

means for determining that a bill payment needs to be made based on comparing the bill due date with the current date; and

means for providing an alert notification to the user indicating the bill due date corresponding to the bill associated with the pre-recorded web navigation script.
A30. The means of embodiment A29, further comprising:

means for providing, as part of the alert notification, the user interface element to the user interface of the consolidated bill payment mobile application that activates the playback of the pre-recorded web navigation automation script for user bill payment.
A31. The means of embodiment A26, further comprising:

means for generating a payment receipt notification after completion of user bill payment using the pre-recorded web navigation automation script; and

means for providing the generated payment receipt notification.
A32. The means of embodiment A31, further comprising:

means for modifying a visual attribute of a user interface element of the user interface of the consolidated bill payment mobile application after generating the payment receipt notification.

In order to address various issues and advance the art, the entirety of this application for DIRECT BILL PAYMENT APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a DBP individual and/or enterprise user, database configuration and/or relational model, data type, data transmission and/or network framework, syntax structure, and/or the like, various embodiments of the DBP may be implemented that enable a great deal of flexibility and customization. For example, aspects of the DBP may be adapted for project management, critical path management, office productivity applications, and/or the like. While various embodiments and discussions of the DBP have been directed to transaction processing, however, it is to be understood that the embodiments described herein may be readily configured and/or customized for a wide variety of other applications and/or implementations.

What is claimed is:

1. An automated bill payment processor-implemented method, comprising:
obtaining an indication to execute a pre-recorded web navigation automation script for user bill payment;
parsing the obtained indication to identify a user and a bill associated with the user;
accessing from a database a pre-recorded web navigation automation script for payment of the bill associated with the identified user; and
executing an automated web navigation action based on the pre-recorded web navigation automation script.

2. The method of claim 1, further comprising:
parsing the pre-recorded web navigation script;
identifying a command included in the pre-recorded web navigation automation script; and
executing the automated web navigation action according to the identified command included in the pre-recorded web navigation automation script.

3. The method of claim 1, wherein the indication to execute the pre-recoded web navigation script is obtained from a user device.

4. The method of claim 2, further comprising:
obtaining a bill due date corresponding to the bill associated with the pre-recorded web navigation automation script;
comparing a current date with the obtained bill due date;
determining that a bill payment needs to be made based on comparing the bill due date with the current date; and
generating the indication to execute the pre-recorded web navigation automation script for user bill payment.

5. The method of claim 1, further comprising:
obtaining a bill due date corresponding to a bill associated with the pre-recorded web navigation automation script;
comparing a current date with the obtained bill due date;
determining that a bill payment needs to be made based on comparing the bill due date with the current date; and
providing an alert notification indicating the bill due date corresponding to the bill associated with the pre-recorded web navigation automation script.

6. The method of claim 1, further comprising:
generating a payment receipt notification after completion of user bill payment using the pre-recorded web navigation automation script; and
providing the generated payment receipt notification.

7. The method of claim 1, further comprising:
accessing user payment card data from a database; and
utilizing the user payment card data to complete user bill payment using the pore-recorded web navigation automation script.

8. The method of claim 7, wherein the user payment card data comprises data on a user payment card selected from a virtual wallet.

9. An automated bill payment system, comprising:
a processor; and
a memory disposed in communication with the processor and storing processor-executable instructions to:
obtain an indication to execute a pre-recorded web navigation automation script for user bill payment;
parse the obtained indication to identify a user and a bill associated with the user;
access from a database a pre-recorded web navigation automation script for payment of the bill associated with the identified user; and
execute an automated web navigation action based on the pre-recorded web navigation automation script.

10. The system of claim 9, the memory further storing instructions to:
parse the pre-recorded web navigation script;
identify a command included in the pre-recorded web navigation automation script; and
execute the automated web navigation action according to the identified command included in the pre-recorded web navigation automation script.

11. The system of claim 9, wherein the indication to execute the pre-recoded web navigation script is obtained from a user device.

12. The system of claim 10, the memory further storing instructions to:
obtain a bill due date corresponding to the bill associated with the pre-recorded web navigation automation script;
compare a current date with the obtained bill due date;
determine that a bill payment needs to be made based on comparing the bill due date with the current date; and
generate the indication to execute the pre-recorded web navigation automation script for user bill payment.

13. The system of claim 9, the memory further storing instructions to:
obtain a bill due date corresponding to a bill associated with the pre-recorded web navigation automation script;
compare a current date with the obtained bill due date;
determine that a bill payment needs to be made based on comparing the bill due date with the current date; and
provide an alert notification indicating the bill due date corresponding to the bill associated with the pre-recorded web navigation automation script.

14. The system of claim 9, the memory further storing instructions to:
generate a payment receipt notification after completion of user bill payment using the pre-recorded web navigation automation script; and
provide the generated payment receipt notification.

15. The system of claim 9, the memory further storing instructions to:
access user payment card data from a database; and
utilize the user payment card data to complete user bill payment using the pore-recorded web navigation automation script.

16. The system of claim 15, wherein the user payment card data comprises data on a user payment card selected from a virtual wallet.

17. A processor-readable tangible medium storing processor-executable automated bill payment instructions to:
obtain an indication to execute a pre-recorded web navigation automation script for user bill payment;
parse the obtained indication to identify a user and a bill associated with the user;
access from a database a pre-recorded web navigation automation script for payment of the bill associated with the identified user; and
execute an automated web navigation action based on the pre-recorded web navigation automation script.

18. The medium of claim 17, further storing instructions to:
parse the pre-recorded web navigation script;
identify a command included in the pre-recorded web navigation automation script; and
execute the automated web navigation action according to the identified command included in the pre-recorded web navigation automation script.

19. The medium of claim 17, wherein the indication to execute the pre-recoded web navigation script is obtained from a user device.

20. The medium of claim 18, further storing instructions to:
obtain a bill due date corresponding to the bill associated with the pre-recorded web navigation automation script;
compare a current date with the obtained bill due date;
determine that a bill payment needs to be made based on comparing the bill due date with the current date; and
generate the indication to execute the pre-recorded web navigation automation script for user bill payment.

21. The medium of claim 17, further storing instructions to:
obtain a bill due date corresponding to a bill associated with the pre-recorded web navigation automation script;
compare a current date with the obtained bill due date;
determine that a bill payment needs to be made based on comparing the bill due date with the current date; and
provide an alert notification indicating the bill due date corresponding to the bill associated with the pre-recorded web navigation automation script.

22. The medium of claim 17, further storing instructions to:
generate a payment receipt notification after completion of user bill payment using the pre-recorded web navigation automation script; and
provide the generated payment receipt notification.

23. The medium of claim 17, further storing instructions to:
access user payment card data from a database; and
utilize the user payment card data to complete user bill payment using the pore-recorded web navigation automation script.

24. The medium of claim 23, wherein the user payment card data comprises data on a user payment card selected from a virtual wallet.

25. An automated bill payment means, comprising:
obtaining an indication to execute a pre-recorded web navigation automation script for user bill payment;
parsing the obtained indication to identify a user and a bill associated with the user;
accessing from a database a pre-recorded web navigation automation script for payment of the bill associated with the identified user; and
executing an automated web navigation action based on the pre-recorded web navigation automation script.

26. The means of claim 25, further comprising:
parsing the pre-recorded web navigation script;
identifying a command included in the pre-recorded web navigation automation script; and
executing the automated web navigation action according to the identified command included in the pre-recorded web navigation automation script.

27. The means of claim 25, wherein the indication to execute the pre-recoded web navigation script is obtained from a user device.

28. The means of claim 26, further comprising:
means for obtaining a bill due date corresponding to the bill associated with the pre-recorded web navigation automation script;
means for comparing a current date with the obtained bill due date;
means for determining that a bill payment needs to be made based on comparing the bill due date with the current date; and
means for generating the indication to execute the pre-recorded web navigation automation script for user bill payment.

29. The means of claim 25, further comprising:
means for obtaining a bill due date corresponding to a bill associated with the pre-recorded web navigation automation script;
means for comparing a current date with the obtained bill due date;
means for determining that a bill payment needs to be made based on comparing the bill due date with the current date; and
means for providing an alert notification indicating the bill due date corresponding to the bill associated with the pre-recorded web navigation automation script.

30. The means of claim 25, further comprising:
means for generating a payment receipt notification after completion of user bill payment using the pre-recorded web navigation automation script; and
means for providing the generated payment receipt notification.

31. The means of claim 25, further comprising:
means for accessing user payment card data from a database; and
means for utilizing the user payment card data to complete user bill payment using the pore-recorded web navigation automation script.

32. The means of claim 31, wherein the user payment card data comprises data on a user payment card selected from a virtual wallet.
